(19) United States
(12) Patent Application Publication
(10) Pub. No.: US 2021/0090211 A1
(43) Pub. Date: Mar. 25, 2021

(54) IMAGE PROCESSING METHOD, NON-TRANSITORY RECORDING MEDIUM, IMAGE PROCESSING APPARATUS, AND IMAGE PROCESSING SYSTEM

(71) Applicants: Takafumi TAKEDA, Tokyo (JP); Hidekuni ANNAKA, Saitama (JP); Kenichiro MORITA, Tokyo (JP); Kumiko YOSHIDA, Tokyo (JP); Tomonori AIKAWA, Kanagawa (JP); Hideki SHIRO, Kanagawa (JP); Takuya SONEDA, Kanagawa (JP); Takeshi HOMMA, Kanagawa (JP)

(72) Inventors: Takafumi TAKEDA, Tokyo (JP); Hidekuni ANNAKA, Saitama (JP); Kenichiro MORITA, Tokyo (JP); Kumiko YOSHIDA, Tokyo (JP); Tomonori AIKAWA, Kanagawa (JP); Hideki SHIRO, Kanagawa (JP); Takuya SONEDA, Kanagawa (JP); Takeshi HOMMA, Kanagawa (JP)

(21) Appl. No.: 17/010,839

(22) Filed: Sep. 3, 2020

(30) Foreign Application Priority Data
Sep. 24, 2019 (JP) 2019-173494

(51) Int. Cl. G06T 3/00; H04N 5/232; G06T 3/40

(52) U.S. Cl. CPC G06T 3/0062; H04N 5/232945; G06T 3/4038; H04N 5/23238

(57) ABSTRACT

An image processing method includes receiving settings of a grid for identifying a relative position of a subject included in a spherical image, displaying, on a display, a display image including the spherical image and a grid image superimposed on the spherical image, and receiving an input of rendering to the spherical image in the displayed display image. The grid image is generated in accordance with the received settings of the grid.

### CROSS-REFERENCE TO RELATED APPLICATION

This patent application is based on and claims priority pursuant to 35 U.S.C. § 119(a) to Japanese Patent Application No. 2019-173494 filed on Sep. 24, 2019 in the Japan Patent Office, the entire disclosure of which is hereby incorporated by reference herein.

### BACKGROUND

### Technical Field

The present disclosure relates to an image processing method, a non-transitory recording medium, an image processing apparatus, and an image processing system.

### Description of the Related Art

A special image capturing apparatus (e.g., digital camera) has been widely used which is capable of acquiring a 360-degree spherical panoramic image in a single shot. There is also an application program enabling rendering, processing, and editing of a spherical image captured by such a digital camera.

Methods of performing rendering (i.e., writing) on such a spherical mage include a method of performing rendering while displaying the entirety of the spherical image on a two-dimensional plane as an equirectangular projection image generated by the equirectangular projection method and a method of performing rendering while displaying on a two-dimensional plane a perspective projection image, which is a viewable area cut out from the spherical image as a part of the spherical image. There is also a method of rendering a spherical image from scratch with a dedicated application program.

According to the first method, however, it is difficult for a user to perform rendering at a desired position on the spherical image because of increased distortion in the image generated by the equirectangular projection method. Further, according to the second method, the range of display is limited in the perspective projection image, preventing the user from performing rendering while checking the entire spherical image.

### SUMMARY

In one embodiment of this invention, there is provided an improved image processing method that includes, for example, receiving settings of a grid for identifying a relative position of a subject included in a spherical image, displaying, on a display, a display image including the spherical image and a grid image superimposed on the spherical image, and receiving an input of rendering to the spherical image in the displayed display image. The grid image is generated in accordance with the received settings of the grid.

In one embodiment of this invention, there is provided a non-transitory recording medium storing a plurality of instructions which, when executed by one or more processors, cause the processors to perform the above-described image processing method.

In one embodiment of this invention, there is provided an improved image processing apparatus that includes, for example, circuitry that receives settings of a grid for identifying a relative position of a subject included in a spherical image, controls a display to display a display image including the spherical image and a grid image superimposed on the spherical image, and receives an input of rendering to the spherical image in the displayed display image. The grid image is generated in accordance with the received settings of the grid.

In one embodiment of this invention, there is provided an improved image processing system that includes, for example, the above-described image processing apparatus and an image capturing apparatus. The image capturing apparatus is communicable with the image processing apparatus, and generates the spherical image from a plurality of captured images.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1A is a right side view of an image capturing apparatus of an embodiment of the present invention;

FIG. 1B is a rear view of the image capturing apparatus of the embodiment;

FIG. 1C is a plan view of the image capturing apparatus of the embodiment;

FIG. 2 is a conceptual diagram illustrating use of the image capturing apparatus of the embodiment;

FIG. 3A is a diagram illustrating a front hemispherical image captured by the image capturing apparatus of the embodiment;

FIG. 3B is a diagram illustrating a rear hemispherical image captured by the image capturing apparatus of the embodiment;

FIG. 3C is a diagram illustrating an equirectangular projection image generated from the hemispherical images by the equirectangular projection method;

FIG. 4A is a conceptual diagram illustrating the equirectangular projection image covering a sphere;

FIG. 4B is a diagram illustrating a spherical image obtained from the equirectangular projection image;

FIG. 5 is a diagram illustrating respective positions of a virtual camera and a viewable area of the spherical image when the spherical image is expressed as a three-dimensional solid sphere;

FIG. 6 is a diagram illustrating the relationship between viewable area information and the image of the viewable area;

FIG. 7 is a diagram illustrating a point in a three-dimensional Euclidean space represented by spherical coordinates;

FIG. 8 is a diagram illustrating rotation of the point in the three-dimensional Euclidean space expressed in Euler angles;

FIG. 9 is a schematic view illustrating an example of an image processing system of the embodiment;

FIG. 10 is a diagram illustrating an example of the hardware configuration of the image capturing apparatus included in the image processing system of the embodiment;

FIG. 11 is a diagram illustrating an example of the hardware configuration of an image forming apparatus (a personal computer) included in the image processing system of the embodiment;

FIG. 12 is a diagram illustrating an example of the functional configuration of the image processing system of the embodiment;

FIG. 13 is a conceptual diagram illustrating an example of a grid setting management table of the embodiment;

FIG. 14 is a sequence diagram illustrating an example of a rendering process performed on the spherical image in the image processing system of the embodiment;

FIG. 15 is a diagram illustrating an example of a rendering input screen displayed on the image processing apparatus of the embodiment;

FIG. 16 is a flowchart illustrating an example of a grid display process performed by the image processing apparatus of the embodiment;

FIG. 17 is a flowchart illustrating an example of a grid image generation process performed by the image processing apparatus of the embodiment;

FIG. 18 is a conceptual diagram illustrating an example of grid rendering in a three-dimensional Euclidean space;

FIGS. 19A and 19B are diagrams illustrating examples of a display image displayed on the image processing apparatus of the embodiment;

FIGS. 20A and 20B are diagrams illustrating other examples of the display image displayed on the image processing apparatus of the embodiment;

FIGS. 21A and 21B are diagrams illustrating still other examples of the display image displayed on the image processing apparatus of the embodiment;

FIG. 22 is a flowchart illustrating an example of a display image rotation process performed by the image processing apparatus of the embodiment;

FIGS. 23A, 23B, 23C, and 23D are diagrams illustrating examples of a display state of the display image displayed on the image processing apparatus of the embodiment when the display image is rotated about the Z-axis;

FIGS. 24A, 24B, 24C, and 24D are diagrams illustrating examples of the display state of the display image displayed on the image processing apparatus of the embodiment when the display image is rotated about the Y-axis; and

FIG. 25 is a flowchart illustrating an example of a rendering process on the spherical image performed by the image processing apparatus of the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An overview of an embodiment of the present invention will be described.

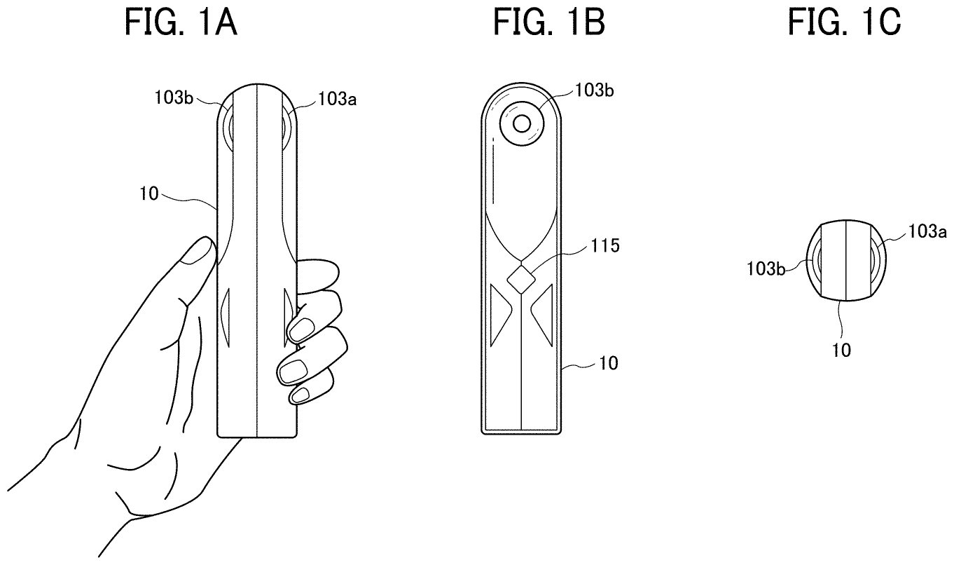

A method of generating a spherical image will be described with FIGS. 1A, 1B, and 1C to FIG. 8. The exterior of an image capturing apparatus 10 of the embodiment will first be described with FIGS. 1A, 1B, and 1C.

The image capturing apparatus 10 is a digital camera for obtaining captured images, based on which a 360-degree spherical panoramic image is generated. FIG. 1A is a right side view of the image capturing apparatus 10. FIG. 1B is a rear view of the image capturing apparatus 10. FIG. 1C is a plan view of the image capturing apparatus 10.

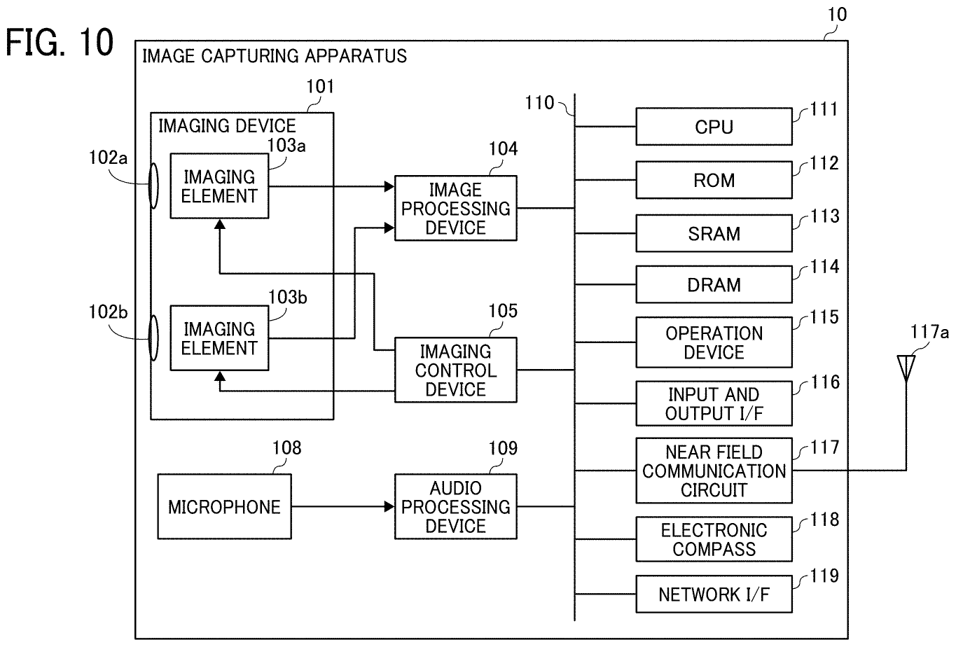

As illustrated in FIG. 1A, the image capturing apparatus 10 has a size suitable for being held by a human hand. As illustrated in FIGS. 1A, 1B, and 1C, an upper portion of the image capturing apparatus 10 is equipped with imaging elements 103a and 103b, which are formed on one surface and the other surface, respectively, of the image capturing apparatus 10. Each of the imaging elements 103a and 103b is implemented by an image sensor, and is used with an optical member (e.g., a lens 102a or 102b in FIG. 10) capable of capturing a hemispherical image with an angle of view of at least 180 degrees. As illustrated in FIG. 1B, the other surface of the image capturing apparatus 10 with the imaging element 103b is equipped with an operation device 115 including a shutter button.

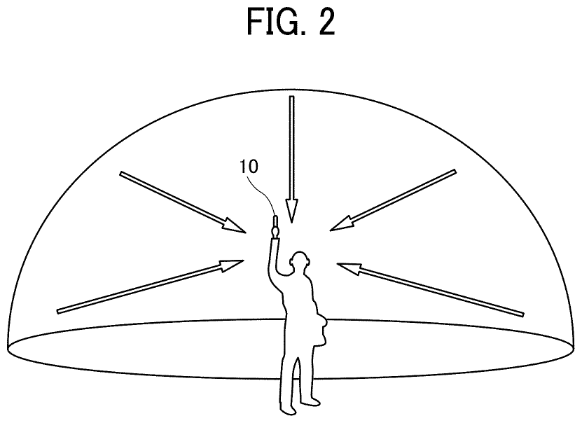

A use situation of the image capturing apparatus 10 will be described with FIG. 2.

FIG. 2 is a conceptual diagram illustrating use of the image capturing apparatus 10. As illustrated in FIG. 2, the image capturing apparatus 10 is used as held by a hand of a user to capture the image of a subject around the user, for example. In this case, the image of the subject around the user is captured by the imaging elements 103a and 103b illustrated in FIGS. 1A, 1B, and 1C to obtain two hemispherical images.

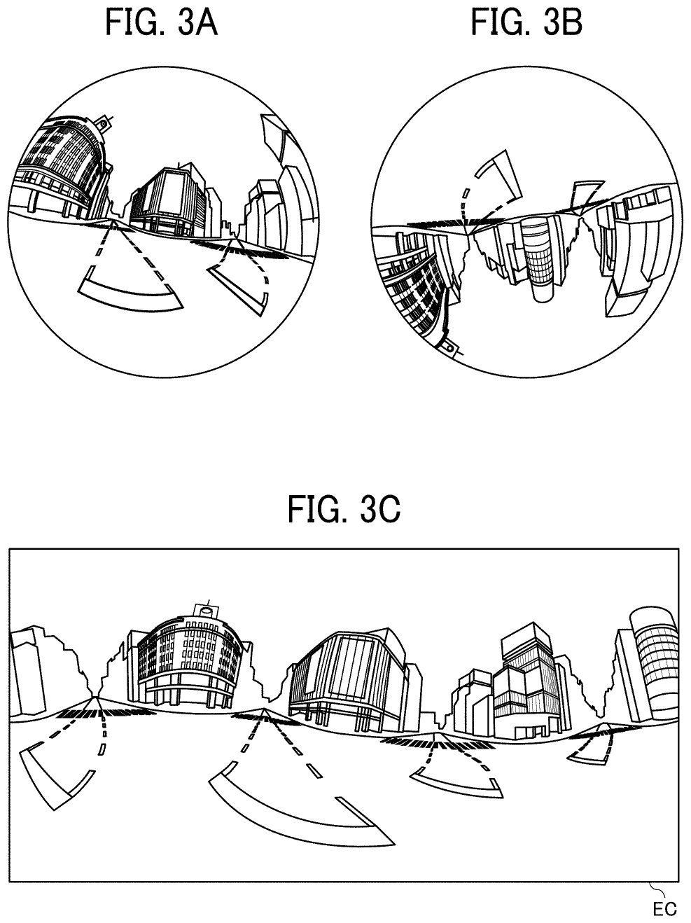

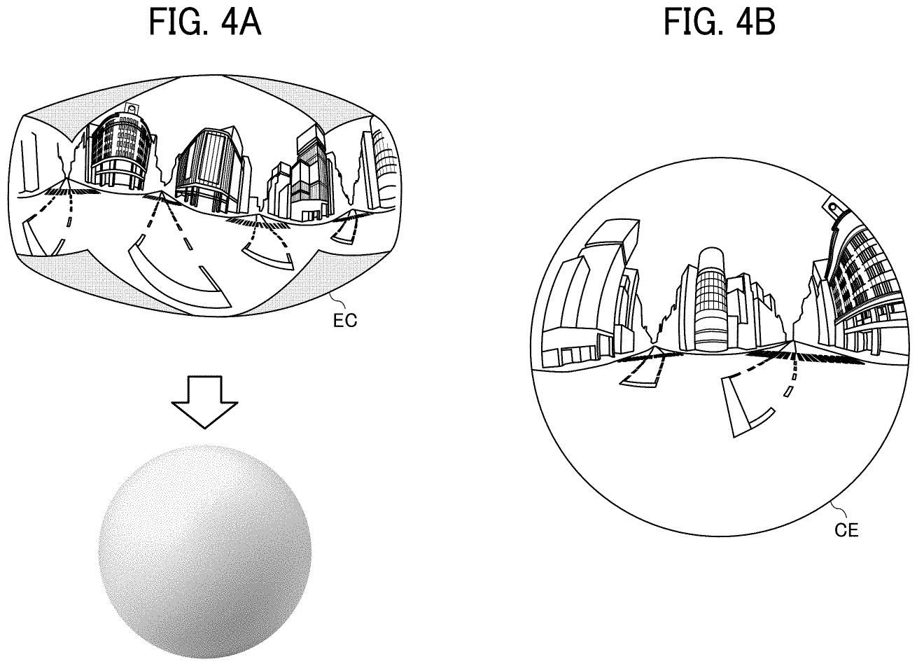

An overview of a process of generating the spherical image from the images captured by the image capturing apparatus 10 will be described with FIGS. 3A, 3B, and 3C and FIGS. 4A and 4B.

FIG. 3A is a diagram illustrating a front hemispherical image captured by the image capturing apparatus 10. FIG. 3B is a diagram illustrating a rear hemispherical image captured by the image capturing apparatus 10. FIG. 3C is a diagram illustrating an image generated from the hemispherical images, as expressed by the equirectangular projection method (hereinafter referred to as the equirectangular projection image EC). FIG. 4A is a conceptual diagram illustrating the equirectangular projection image EC covering a sphere. FIG. 4B is a diagram illustrating a spherical image CE obtained from the equirectangular projection image EC.

As illustrated in FIG. 3A, the front hemispherical image, which is obtained by the imaging element 103a, is distorted by the lens 102a. Further, as illustrated in FIG. 3B, the rear hemispherical image, which is obtained by the imaging element 103b, is distorted by the lens 102b. The image capturing apparatus 10 combines the front hemispherical image and the rear hemispherical image rotated therefrom by 180 degrees, to thereby generate the equirectangular projection image EC as illustrated in FIG. 3C.

Then, with an application programming interface (API) such as open graphics library for embedded systems (OpenGL ES, registered trademark), the image capturing apparatus 10 places the equirectangular projection image EC on the surface of a sphere to cover the spherical surface, as illustrated in FIG. 4A. Thereby, the spherical image CE as illustrated in FIG. 4B is generated. The spherical image CE is thus expressed as the equirectangular projection image EC facing the center of the sphere. OpenGL ES is a graphics library used to visualize two-dimensional (2D) or three-dimensional (3D) data. The spherical image CE may be a still or video image.

As described above, the spherical image CE is an image placed on a sphere to cover the spherical surface, and thus is perceived as unnatural to human eyes. Therefore, the image capturing apparatus 10 displays a part of the spherical image CE as a planar image with less distortion so that the displayed image is perceived as natural to human eyes. Hereinafter, the above-described part of the spherical image CE will be described as the viewable area T, and the image of the viewable area T will be described as the viewable area image Q.

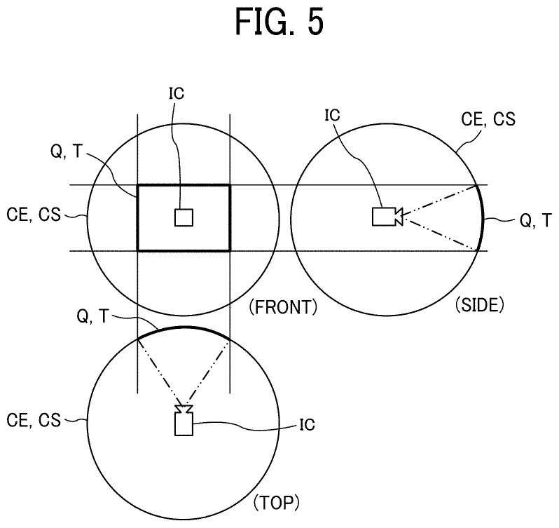

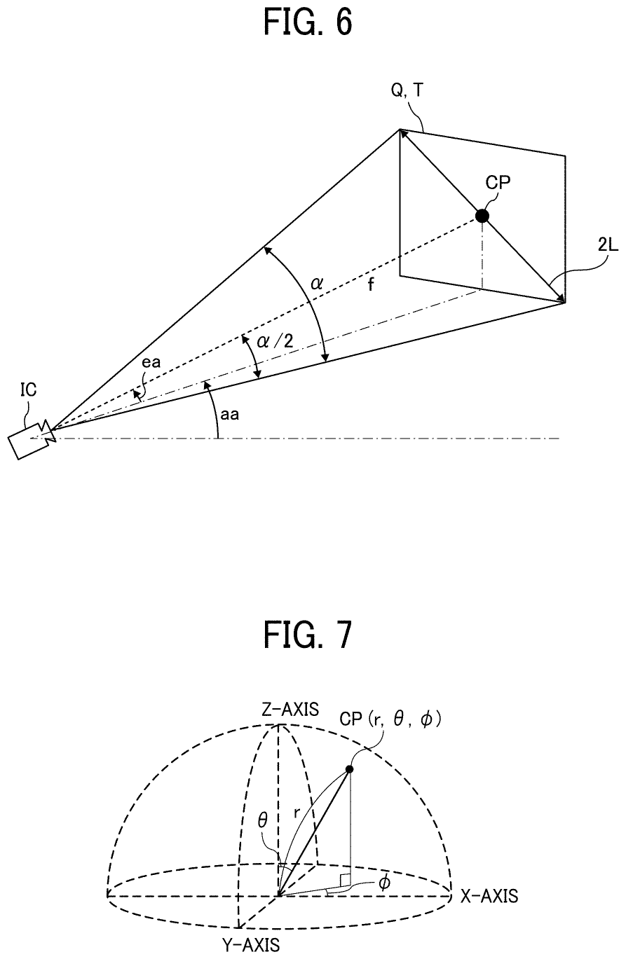

Display of the viewable area T will be described with FIGS. 5 and 6.

FIG. 5 is a diagram illustrating the respective positions of a virtual camera IC and the viewable area T when the spherical image CE is expressed as a three-dimensional solid sphere CS. The position of the virtual camera IC corresponds to the position of the viewpoint of the user viewing the spherical image CE expressed as the three-dimensional solid sphere CS, i.e., the position of the user's viewpoint relative to the spherical image CE. Hereinafter, the position of the viewpoint of the user viewing the spherical image CE may also be referred to as the viewpoint position for viewing the spherical image.

In FIG. 5, the spherical image CE in FIG. 4B is expressed as the three-dimensional solid sphere CS. The viewable area T of the spherical image CE corresponds to an image capturing area of the virtual camera IC, and is identified by viewable area information. The viewable area information represents the image capturing direction and the angle of view of the virtual camera IC in a three-dimensional virtual space including the spherical image CE. The viewable area image Q, which is the image of the viewable area T, is displayed on a particular display as the image in the image capturing area of the virtual camera IC. The viewable area image Q is represented by initially set (i.e., default) viewable area information (i.e., display parameters). In the following description of the viewable area T, the image capturing direction (ea, aa) and the angle of view a of the virtual camera IC will be used. The viewable area T, however, may be expressed not with the angle of view a and a distance f (see FIG. 6) but with the image capturing area (X, Y, Z) of the virtual camera IC corresponding to the viewable area T.

The relationship between the viewable area information and the image of the viewable area T will be described with FIG. 6.

FIG. 6 is a diagram illustrating the relationship between the viewable area information and the image of the viewable area T. As illustrated in FIG. 6, ea, aa, and a represent the elevation angle, the azimuth angle, and the angle of view, respectively, of the virtual camera IC. That is, the attitude of the virtual camera IC is changed such that the point of interest of the virtual camera IC represented by the image capturing direction (ea, aa) corresponds to a center point CP of the viewable area T as the image capturing area of the virtual camera IC. As illustrated in FIG. 6, when the diagonal angle of view of the viewable area T is expressed as the angle of view a of the virtual camera IC, the center point CP corresponds to (x, y) parameters of the viewable area information. The viewable area image Q is the image of the viewable area T of the spherical image CE. Further, f represents the distance from the virtual camera IC to the center point CP, and L represents the distance between a given vertex of the viewable area T and the center point CP. Thus, 2L represents the length of a diagonal of the viewable area T. Further, in FIG. 6, a trigonometric function typically expressed as equation (1) given below holds.

$$[ Math . 1 ]$$

$$L \text{/} f = tan ( \frac{α}{2} ) \qquad ( 1 )$$

The above-described image capturing apparatus 10 is an example of an image capturing apparatus capable of acquiring a wide-angle image. The spherical image is an example of the wide-angle image. The wide-angle image is typically captured with a wide-angle lens capable of capturing an image in a range wider than the viewing range of the human eye. Further, the wide-angle image normally refers to the image captured with a lens having a focal length of 35 mm or less in 35 mm film equivalent.

FIG. 7 is a diagram illustrating a point in a three-dimensional Euclidean space represented by spherical coordinates. The position coordinates of the center point CP are expressed as (r, θ, φ) in a spherical polar coordinate system. Herein, r, θ, and φ represent the radius vector, the polar angle, and the azimuth angle, respectively. The radius vector r corresponds to the distance from the center point CP to the origin of the three-dimensional virtual space including the spherical image CE, and thus is equal to the distance f. FIG. 7 illustrates the relationships between these elements. The following description will be given with the position coordinates (r, θ, φ) of the virtual camera IC.

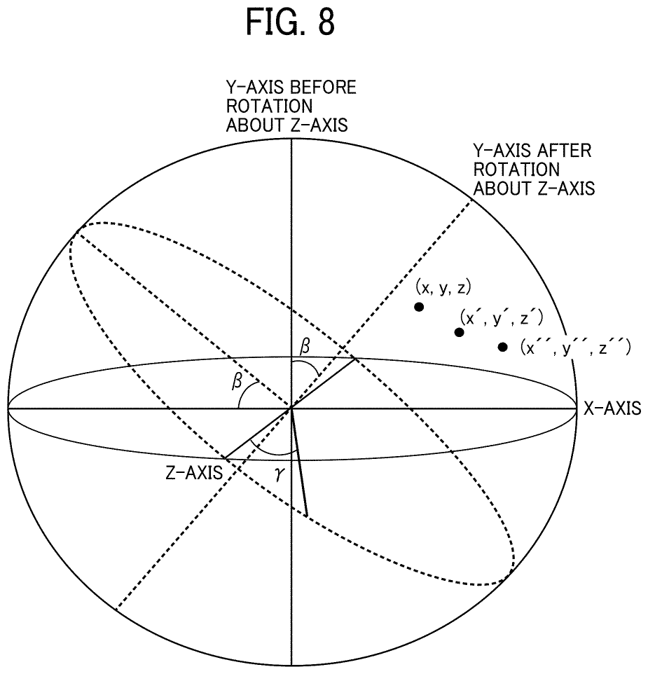

FIG. 8 is a diagram illustrating rotation of the point in the three-dimensional Euclidean space expressed in Euler angles. FIG. 8 illustrates an example in which the rotation of the center point CP in FIG. 7 is expressed in Euler angles. Herein, the rotation of the center point CP expressed in Euler angles is executed in the zxy order. The position coordinates of the center point CP are therefore expressed with the XYZ coordinate system converted from the spherical polar coordinate system.

Position coordinates (x′, y′, z′) are obtained by rotating position coordinates (x, y, z) in the three-dimensional Euclidean space about the Z-axis by an angle β. The relationship between the position coordinates (x, y, z) and the post-rotation position coordinates (x′, y′, z′) is expressed by the relational expression in equation (2) given below.

[Math. 2]

x′=cos φₓ+sin φ_{y}

y′=−sin φₓ+cos φ_{y}

z′=z (2)

Further, position coordinates (x″, y″, z″) are obtained by rotating the position coordinates (x′, y′, z′) in the three-dimensional Euclidean space about the Y-axis by an angle γ. The relationship between the position coordinates (x′, y′, z′) and the post-rotation position coordinates (x″, y″, z″) is expressed by the relational expression in equation (3) given below.

[Math. 3]

x″=cos φₓ−sin φ_{y′}

y″=y′

z″=sin φ_{x′}+cos φ_{z′} (3)

If predetermined rendering is performed on the rotated spherical image, calculation is performed to derive the pre-rotation position coordinates (x, y, z) from the post-rotation position coordinates (x″, y″, z″) obtained after the rotation of the rendering image. The position coordinates (x, y, z) are obtained by calculating equation (3) and then equation (2) in the order reverse to the above. Further, with the relational expression in equation (4) given below, the calculated position coordinates (x, y, z) are converted into coordinates (θ, φ) in the three-dimensional Euclidean space, to thereby calculate the values θ and φ in the position coordinates (r, θ, φ) of the center point CP in FIG. 7 corresponding to the position of the rendering image.

$$[ Math . 2 ]$$

$$θ = {tan}^{- 1} ( \frac{x}{z} ) \\ ϕ = {tan}^{- 1} ( \frac{y}{√ {x}^{2} + {z}^{2}} ) \qquad ( 4 )$$

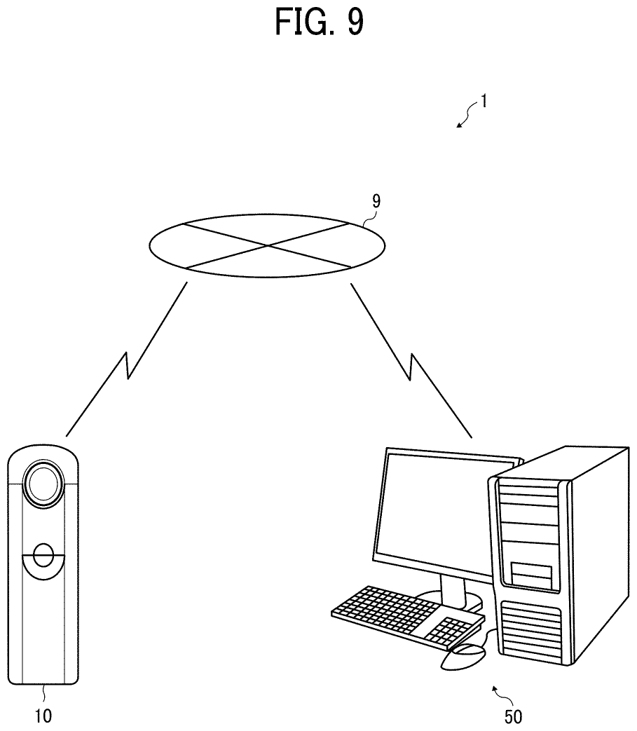

An overview of a configuration of an image processing system 1 of the embodiment will be described with FIG. 9.

FIG. 9 is a schematic view illustrating an example of the image processing system 1 of the embodiment. The image processing system 1 illustrated in FIG. 9 is a system capable of inputting a predetermined rendering image to the spherical image corresponding to the captured images acquired by the image capturing apparatus 10.

As illustrated in FIG. 9, the image processing system 1 of the embodiment includes the image capturing apparatus 10 and a personal computer (PC) 50, which are communicably connected to each other via a communication network 9 that uses the Internet or a local area network (LAN), for example. In the communication network 9, the Internet and an intranet may be connected to each other via a firewall. Further, the communication network 9 may use wireless or wired connection.

As described above, the image capturing apparatus 10 is a special digital camera for capturing the image of a subject (e.g., an object or surroundings) and obtaining two hemispherical images, based on which the spherical image is generated.

The PC 50 is an image processing apparatus that performs image processing on the still or video image acquired from the image capturing apparatus 10. Via the communication network 9, the PC 50 acquires the spherical image corresponding to the images captured by the image capturing apparatus 10. A predetermined application program is installed in the PC 50 to enable a user of the PC 50 to perform rendering on the spherical image acquired from the image capturing apparatus 10. The PC 50 may be replaced by a mobile phone or a tablet terminal, for example.

The connection relationship between the apparatuses illustrated in FIG. 9 is illustrative, and thus another connection relationship is possible. For example, the image capturing apparatus 10 and the PC 50 may be directly connected to each other with a near field wireless communication technology or a universal serial bus (USB) cable, without via the communication network 9. Further, the image capturing apparatus 10 may communicate with the PC 50 by connecting to the communication network 9 via a communication terminal with a router function, such as a smartphone. Further, the image processing system 1 may include a server apparatus communicable with the image capturing apparatus 10 and the PC 50 via the communication network 9. In this case, the server apparatus cooperates with the PC 50 to execute the process of the predetermined application program.

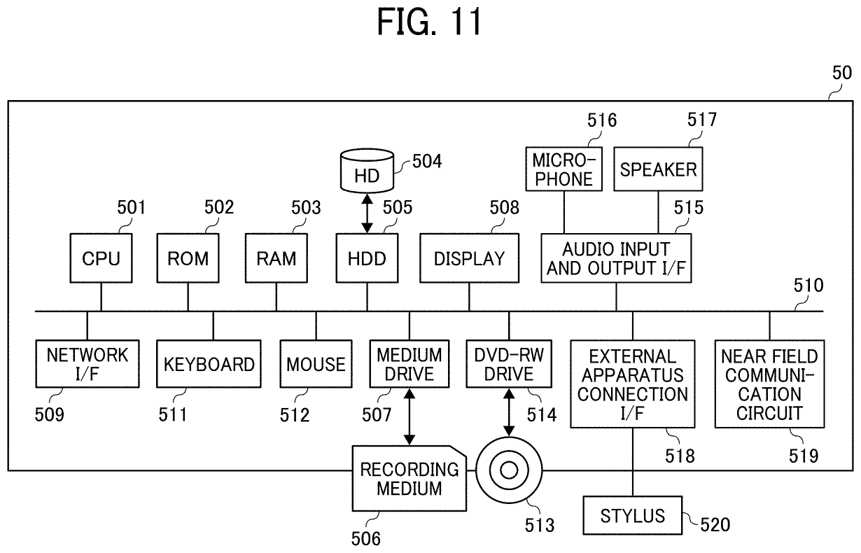

Respective hardware configurations of the apparatuses forming the image processing system 1 will be described with FIGS. 10 and 11. A component may be added to or deleted from each of hardware configurations illustrated in FIGS. 10 and 11.

A hardware configuration of the image capturing apparatus 10 will first be described with FIG. 10.

FIG. 10 is a diagram illustrating an example of the hardware configuration of the image capturing apparatus 10 of the embodiment. The image capturing apparatus 10 described below is a spherical (i.e., all-directional) image capturing apparatus with two imaging elements. However, the number of imaging elements included in the image capturing apparatus 10 may be three or more. Further, the image capturing apparatus 10 is not necessarily required to be an apparatus dedicated to the purpose of capturing the all-directional image. Therefore, an all-directional image capturing device may be additionally attached to a typical digital camera or smartphone, for example, to provide substantially the same functions as those of the image capturing apparatus 10.

As illustrated in FIG. 10, the image capturing apparatus 10 includes an imaging device 101, an image processing device 104, an imaging control device 105, a microphone 108, an audio processing device 109, a central processing unit (CPU) 111, a read only memory (ROM) 112, a static random access memory (SRAM) 113, a dynamic random access memory (DRAM) 114, the operation device 115, an input and output interface (I/F) 116, a near field communication circuit 117, an antenna 117a for the near field communication circuit 117, an electronic compass 118, and a network I/F 119.

The imaging device 101 includes the two wide-angle (i.e., fisheye) lenses 102a and 102b (hereinafter referred to as the lenses 102 where distinction therebetween is unnecessary) and the two imaging elements 103a and 103b corresponding thereto. Each of the lenses 102 has an angle of view of at least 180 degrees to form a hemispherical image. Each of the imaging elements 103a and 103b includes an image sensor, a timing signal generating circuit, and a group of registers, for example. The image sensor may be a complementary metal oxide semiconductor (CMOS) or charge coupled device (CCD) sensor that converts an optical image formed by the lens 102a or 102b into image data in the form of electrical signals and outputs the image data. The timing signal generating circuit generates signals such as a pixel clock signal and a horizontal or vertical synchronization signal for the image sensor. Various commands and parameters for the operation of the imaging element 103a or 103b are set in the group of registers.

Each of the imaging elements 103a and 103b of the imaging device 101 is connected to the image processing device 104 via a parallel I/F bus, and is connected to the imaging control device 105 via a serial I/F bus (e.g., an inter-integrated circuit (I²C) bus). The image processing device 104, the imaging control device 105, and the audio processing device 109 are connected to the CPU 111 via a bus 110. The bus 110 is further connected to the ROM 112, the SRAM 113, the DRAM 114, the operation device 115, the input and output I/F 116, the near field communication circuit 117, the electronic compass 118, and the network I/F 119, for example.

The image processing device 104 receives image data items from the imaging elements 103a and 103b via the parallel I/F bus, performs a predetermined process on the image data items, and combines the processed image data items to generate the data of the equirectangular projection image as illustrated in FIG. 3C.

The imaging control device 105 sets commands in the groups of registers of the imaging elements 103a and 103b via the serial I/F bus such as the I²C bus, with the imaging control device 105 and the imaging elements 103a and 103b acting as a master device and slave devices, respectively. The imaging control device 105 receives the commands from the CPU 111. The imaging control device 105 further receives data such as status data from the groups of registers of the imaging elements 103a and 103b via the serial I/F bus such as the I²C bus, and transmits the received data to the CPU 111.

The imaging control device 105 further instructs the imaging elements 103a and 103b to output the image data when the shutter button of the operation device 115 is pressed down. The image capturing apparatus 10 may have a preview display function or a video display function using a display (e.g., a display 508 of the PC 50 in FIG. 11). In this case, the imaging elements 103a and 103b continuously output the image data at a predetermined frame rate. The frame rate is defined as the number of frames per minute.

The imaging control device 105 also functions as a synchronization controller that cooperates with the CPU 111 to synchronize the image data output time between the imaging elements 103a and 103b. In the present embodiment, the image capturing apparatus 10 is not equipped with a display. The image capturing apparatus 10, however, may be equipped with a display.

The microphone 108 converts sound into audio (signal) data. The audio processing device 109 receives the audio data from the microphone 108 via an I/F bus, and performs a predetermined process on the audio data.

The CPU 111 controls an overall operation of the image capturing apparatus 10, and executes various processes. The ROM 112 stores various programs for the CPU 111. The SRAM 113 and the DRAM 114 are used as work memories to store programs executed by the CPU 111 and data being processed. The DRAM 114 particularly stores image data being processed by the image processing device 104 and processed data of the equirectangular projection image.

The operation device 115 collectively refers to components such as various operation buttons including the shutter button, a power switch, and a touch panel that has a display function and an operation function. The user operates the operation device 115 to input various image capturing modes and image capturing conditions, for example. The input and output I/F 116 collectively refers to interface circuits (e.g., a USB interface circuit) to connect to an external medium (e.g., a secure digital (SD) card) and a PC.

The input and output I/F 116 may be a wireless or wired interface. Via the input and output I/F 116, the data of the equirectangular projection image stored in the DRAM 114 may be recorded on an external medium, or may be transmitted as necessary to an external apparatus or terminal.

The near field communication circuit 117 communicates with an external apparatus or terminal via the antenna 117a of the image capturing apparatus 10 in accordance with a near field wireless communication technology conforming to a standard such as near field communication (NFC), Bluetooth (registered trademark), or wireless fidelity (Wi-Fi, registered trademark). The data of the equirectangular projection image may also be transmitted to an external apparatus or terminal via the near field communication circuit 117.

The electronic compass 118 outputs orientation and tilt information by calculating the orientation and tilt (i.e., the roll rotation angle) of the image capturing apparatus 10 from the geomagnetism. The orientation and tilt information is an example of related information (i.e., metadata) conforming to the exchangeable image file format (Exif) standard. The orientation and tilt information is used in image processing such as image correction of the captured image. The related information includes data such as the date and time of capturing the image and the data capacity of the image data.

The network I/F 119 is an interface for performing data communication using the communication network 9 such as the Internet via a router, for example.

A hardware configuration of the PC 50 will be described with FIG. 11.

FIG. 11 is a diagram illustrating an example of the hardware configuration of the PC 50 (i.e., the image processing apparatus) of the embodiment. The PC 50 is implemented by a typical computer. The PC 50 includes a CPU 501, a ROM 502, a RAM 503, a hard disk (HD) 504, a hard disk drive (HDD) 505, a medium drive 507, and a display 508.

The CPU 501 controls an overall operation of the PC 50. The CPU 501 is an arithmetic device that executes a process by reading a program or data stored in a memory such as the ROM 502 onto the RAM 503, to thereby implement functions of the PC 50. The ROM 502 stores a program used to drive the CPU 501 such as an initial program loader (IPL). The RAM 503 is used as a work area for the CPU 501. The HDD 505 controls writing and reading of various data to and from the HD 504 under the control of the CPU 501. The HD 504 stores various data of a program, for example. The medium drive 507 controls writing (i.e., storage) and reading of data to and from a recording medium 506 such as a flash memory. The display 508 displays various information such as a cursor, menus, windows, text, and images.

The PC 50 further includes a network I/F 509, a keyboard 511, a mouse 512, a digital versatile disk rewritable (DVD-RW) drive 514, an audio input and output I/F 515, a microphone 516, a speaker 517, an external apparatus connection I/F 518, a near field communication circuit 519, and a bus line 510.

The network I/F 509 is an interface for performing data communication via the communication network 9. The keyboard 511 is an input device including a plurality of keys for inputting text, numerical values, and various instructions, for example. The mouse 512 is an input device used to select and execute various instructions, select a processing target, and move the cursor, for example. The DVD-RW drive 514 controls reading of various data from a DVD-RW 513 as an example of a removable recording medium. The DVD-RW 513 may be replaced by a DVD-recordable (DVD-R), for example. Further, the DVD-RW drive 514 may be replaced by a Blu-ray (registered trademark) drive for controlling writing and reading of various data to and from a Blu-ray disc or a compact disc rewritable (CD-RW) drive for controlling writing and reading of various data to and from a CD-RW, for example.

The microphone 516 is a built-in sound collecting device for inputting sound. The audio input and output I/F 515 is a circuit that processes input of audio signals from the microphone 516 and output of audio signals to the speaker 517 under the control of the CPU 501. The external apparatus connection I/F 518 is an interface for connecting the PC 50 to various external apparatuses. The external apparatus connection I/F 518 has the function of a contact sensor that detects the contact of a stylus 520 or a hand of a user on the display 508, for example. With the function of the contact sensor, the external apparatus connection I/F 518 inputs and detects coordinates corresponding to a position on the display 508 contacted by the stylus 520. The stylus 520 is an example of an external input device for performing predetermined rendering on the display 508. In this disclosure, rendering is any processing to make something visible, such as writing or drawing. The near field communication circuit 519 is a communication circuit for communicating with an external apparatus with a near field wireless communication technology conforming to a standard such as NFC, Bluetooth, or Wi-Fi. The bus line 510 includes an address bus and a data bus for electrically connecting the CPU 501 and the other components in FIG. 11 to each other.

Each of the above-described programs may be distributed as recorded on a computer readable recording medium in an installable or executable file format. Examples of the recording medium include a CD-recordable (CD-R), a DVD, a Blu-ray disc, and an SD card. The recording medium may be shipped to the market as a program product. For example, the PC 50 executes a program according to an embodiment of the present invention to implement an image processing method according to an embodiment of the present invention.

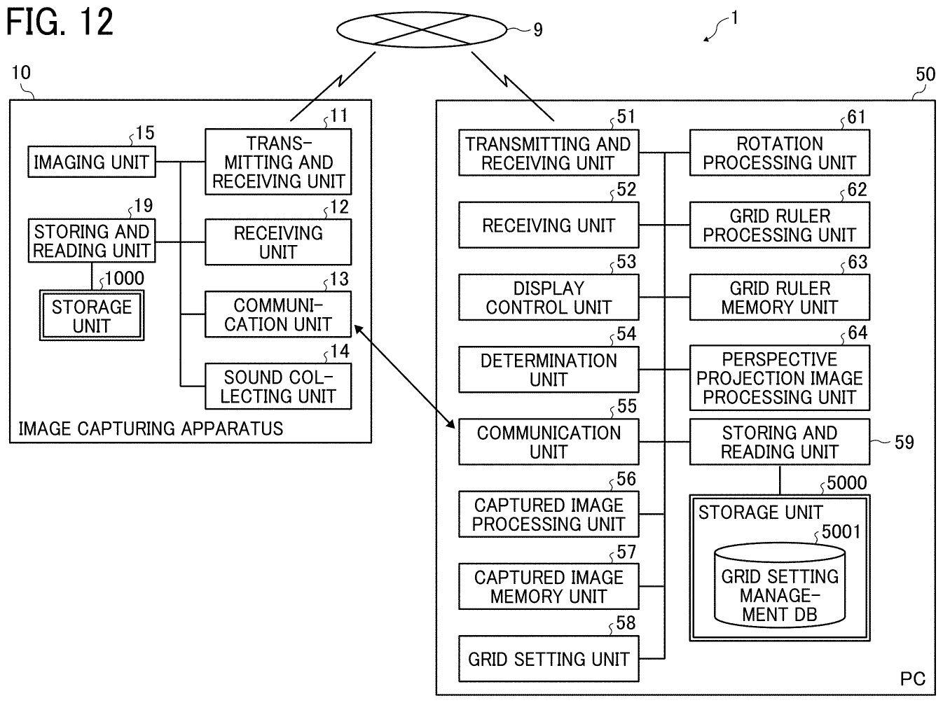

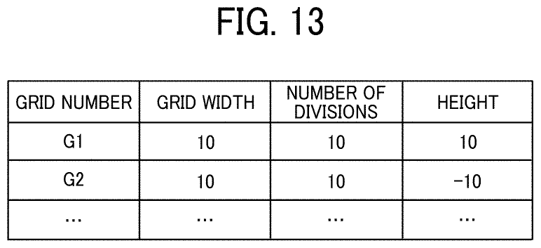

Respective functional configurations of the image capturing apparatus 10 and the PC 50 forming parts of the image processing system 1 of the embodiment will be described with FIGS. 12 and 13.

A functional configuration of the image capturing apparatus 10 will first be described with FIG. 12.

FIG. 12 is a diagram illustrating an example of the functional configuration of the image processing system 1 of the embodiment. The image capturing apparatus 10 includes a transmitting and receiving unit 11, a receiving unit 12, a communication unit 13, a sound collecting unit 14, an imaging unit 15, and a storing and reading unit 19. Each of these units is a function or device implemented when at least one of the components illustrated in FIG. 10 operates in response to a command from the CPU 111 in accordance with a program for the image capturing apparatus 10 deployed on the DRAM 114 from the SRAM 113. The image capturing apparatus 10 further includes a storage unit 1000 implemented by the ROM 112, the SRAM 113, and the DRAM 114 illustrated in FIG. 10.

The transmitting and receiving unit 11 is a function mainly implemented by the processing of the CPU 111 and the network I/F 119 in FIG. 10 to transmit and receive various data and information to and from another apparatus via the communication network 9. For example, the transmitting and receiving unit 11 transmits captured image data acquired by the imaging unit 15 to the PC 50 via the communication network 9.

The receiving unit 12 is a function mainly implemented by the processing of the CPU 111 and the operation device 115 in FIG. 10 to receive an operation input by the user of the image capturing apparatus 10.

The communication unit 13 is a function mainly implemented by the processing of the CPU 111 and the input and output I/F 116 or the near field communication circuit 117 in FIG. 10 to communicate with a communication unit 55 of the PC 50 with a near field wireless communication technology or a cable, for instance. For example, the communication unit 13 transmits the captured image data acquired by the imaging unit 15 to the communication unit 55 of the PC 50.

The sound collecting unit 14 is a function mainly implemented by the processing of the CPU 111, the microphone 108, and the audio processing device 109 in FIG. 10 to collect sounds around the image capturing apparatus 10.

The imaging unit 15 is a function mainly implemented by the processing of the CPU 111, the imaging device 101, the image processing device 104, and the imaging control device 105 in FIG. 10 to capture the image of the subject such as the surroundings of the image capturing apparatus 10 to obtain the captured image data.

The storing and reading unit 19 is a function mainly implemented by the processing of the CPU 111 in FIG. 10 to store various data and information in the storage unit 1000 and read therefrom various data and information.

A functional configuration of the PC 50 will be described with FIG. 12.

The PC 50 includes a transmitting and receiving unit 51, a receiving unit 52, a display control unit 53, a determination unit 54, a communication unit 55, a captured image processing unit 56, a captured image memory unit 57, a grid setting unit 58, a rotation processing unit 61, a grid ruler processing unit 62, a grid ruler memory unit 63, a perspective projection image processing unit 64, and a storing and reading unit 59. Each of these units is a function or device implemented when at least one of the components illustrated in FIG. 11 operates in response to a command from the CPU 501 in accordance with a program for the PC 50 deployed on the RAM 503 from the HD 504. The PC 50 further includes a storage unit 5000 implemented by the ROM 502, the RAM 503, and the HD 504 illustrated in FIG. 11.

The transmitting and receiving unit 51 is a function mainly implemented by the processing of the CPU 501 and the network I/F 509 in FIG. 11 to transmit and receive various data and information to and from another apparatus via the communication network 9. For example, the transmitting and receiving unit 51 receives (i.e., acquires) the captured image data transmitted from the image capturing apparatus 10 via the communication network 9.

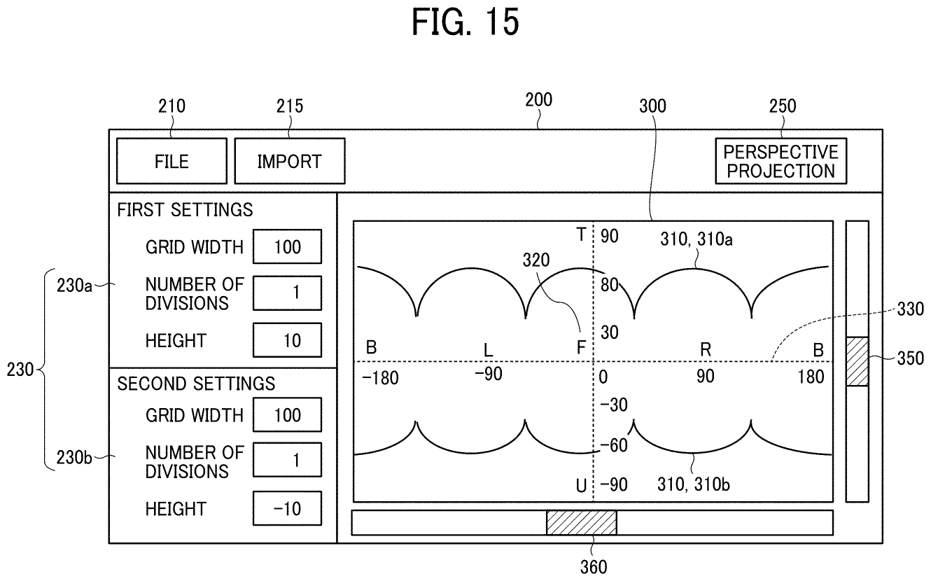

The receiving unit 52 is a function mainly implemented by the processing of the CPU 501, the keyboard 511, the mouse 512, and the stylus 520 in FIG. 11 to receive various selections and inputs by the user. For example, with a later-described rendering input screen 200 (see FIG. 15), the receiving unit 52 receives settings of a grid for identifying the relative position of the subject included in the spherical image. The grid may also be referred to as ruled lines, cells, auxiliary lines, a guide, or grid lines, for example. Further, for example, the receiving unit 52 receives input of predetermined rendering to the spherical image displayed on the display 508.

The display control unit 53 is a function mainly implemented by the processing of the CPU 501 in FIG. 11 to control the display 508 of the PC 50 to display various screens. For example, the display control unit 53 controls the display 508 to display the rendering input screen 200. The display control unit 53 further controls the display 508 to display the spherical image corresponding to the captured image based on the captured image data acquired from the image capturing apparatus 10.

The determination unit 54 is a function mainly implemented by the processing of the CPU 501 in FIG. 11 to make various determinations.

The communication unit 55 is a function mainly implemented by the processing of the CPU 501 and the external apparatus connection I/F 518 or the near field communication circuit 519 in FIG. 11 to communicate with the communication unit 13 of the image capturing apparatus 10 with a near field wireless communication technology or a cable, for instance. For example, the communication unit 55 receives (i.e., acquires) the captured image data transmitted from the communication unit 13 of the image capturing apparatus 10.

The captured image processing unit 56 is a function mainly implemented by the processing of the CPU 501 in FIG. 11 to perform image processing on the spherical image displayed on the display 508. For example, the captured image processing unit 56 receives input of predetermined rendering to the spherical image displayed on the display 508.

The captured image memory unit 57 is a function mainly implemented by the processing of the CPU 501, the ROM 502, and the RAM 503 in FIG. 11 to temporarily store the spherical image displayed on the display 508 to execute the image processing by the captured image processing unit 56 on the spherical image.

The grid setting unit 58 is a function mainly implemented by the processing of the CPU 501 in FIG. 11 to perform the setting of the grid for identifying the relative position of the subject included in the spherical image.

The rotation processing unit 61 is a function mainly implemented by the processing of the CPU 501 in FIG. 11 to rotate the display image displayed on the display 508 in response to receipt of a rotation request from the user. For example, the rotation processing unit 61 receives an input to a Z-axis scroll bar 350 or a Y-axis scroll bar 360 in FIG. 15, and rotates the display image displayed in a rendering area 300 in FIG. 15 to change the display position or the display direction of the display image.

The grid ruler processing unit 62 is a function mainly implemented by the processing of the CPU 501 in FIG. 11 to generate a grid image and a ruler image. The grid image represents the grid for identifying the relative position of the subject included in the spherical image. The ruler image represents the display position of the spherical image. For example, the grid ruler processing unit 62 generates the grid image based on setting information set in a grid setting management database (DB) 5001 stored in the storage unit 5000.

The grid ruler memory unit 63 is a function mainly implemented by the processing of the CPU 501, the ROM 502, and the RAM 503 in FIG. 11 to temporarily store the grid image and the ruler image generated by the grid ruler processing unit 62.

The perspective projection image processing unit 64 is a function mainly implemented by the processing of the CPU 501 in FIG. 11 to execute a process on a perspective projection image, which corresponds to the image of the viewable area as a part of the spherical image, i.e., the image of the viewable area T (i.e., the viewable area image Q) illustrated in FIGS. 5 and 6, as viewed from the virtual camera IC.

The storing and reading unit 59 is a function mainly implemented by the processing of the CPU 501 in FIG. 11 to store various data and information in the storage unit 5000 and read therefrom various data and information.

FIG. 13 is a conceptual diagram illustrating an example of a grid setting management table of the embodiment. The storage unit 5000 stores the grid setting management DB 5001 configured as the grid setting management table as illustrated in FIG. 13. The grid setting management table stores information of the grid number for identifying a grid to be set, the grid width representing the width of the grid, the number of divisions for dividing the grid, and the relative height of the grid relative to the viewpoint position for viewing the spherical image. The relative height of the grid relative to the viewpoint position for viewing the spherical image represents the position of the grid in the spherical image with reference to the position of the virtual camera IC illustrated in FIGS. 5 and 6, for example. The user of the PC 50 inputs various setting information for the grid setting to the rendering input screen 200. Thereby, the input setting information is stored in the grid setting management table. The number of grids to be set is two in the example of FIG. 13. However, the number of grids to be set is not limited thereto, and may be one or may be three or more. In this case, the number of records in the grid setting management table is changed in accordance with the number of grids to be set.

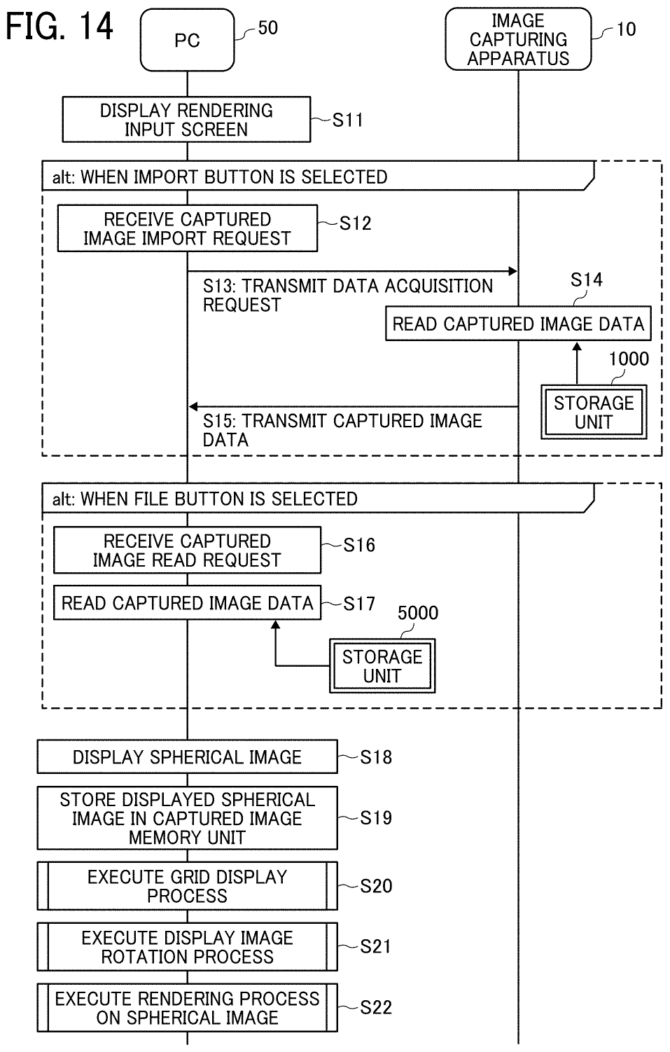

Processes and operations performed in the image processing system 1 of the embodiment will be described with FIGS. 14 to 25.

FIG. 14 is a sequence diagram illustrating an example of a rendering process performed on the spherical image in the image processing system 1 of the embodiment.

The display control unit 53 of the PC 50 first starts the predetermined application program installed in the PC 50 to control the display 508 to display the rendering input screen 200 for inputting rendering to the captured image (step S11).

FIG. 15 is a diagram illustrating an example of the rendering input screen 200 displayed on the PC 50 (i.e, the image processing apparatus) of the embodiment. The rendering input screen 200 illustrated in FIG. 15 is a display screen for the user to input predetermined rendering to the spherical image displayed in the rendering area 300.

A file button 210 is pressed to read, from the storage unit 5000, an electronic file storing the captured image, on which the rendering is to be performed in the rendering area 300. An import button 215 is pressed to import the captured image from the image capturing apparatus 10 connected to the PC 50. The user of the PC 50 presses the file button 210 or the import button 215 to import to the PC 50 the image to which rendering is to be input.

A grid setting area 230 is an area for inputting the setting information of the grid for identifying the relative position of the subject included in the spherical image. For example, the setting information includes the information of the grid width representing the width of the grid, the number of divisions representing the number by which the grid is divided, and the relative height of the grid relative to viewpoint position for viewing the spherical image. The grid setting area 230 includes a grid setting area 230a and a grid setting area 230b. The grid setting area 230a is an area for inputting the setting information of a grid G1 corresponding to a grid image 310a. The grid setting area 230b is an area for inputting the setting information of a grid G2 corresponding to a grid image 310b. For example, the grid image 310a represents a grid rendered on the top surface of the subject in the spherical image, and the grid image 310b represents a grid rendered on the bottom surface of the subject in the spherical image. The user of the PC 50 is able to set a plurality of grids by inputting the setting information of the grids to the grid setting area 230 as described above. The number of settable grids is two in the present example. However, the number of settable grids may be one or may be three or more. In the following description, the grid images 310a and 310b will be collectively referred to as the grid image 310 where distinction therebetween is unnecessary.

The rendering area 300 is an input area for the user to input rendering to the spherical image. For example, the rendering area 300 displays the equirectangular projection image generated by the equirectangular projection method to represent the imported spherical image. In this case, θ and φ in the coordinates (r, θ, φ) illustrated in FIG. 7 are expressed as the value on the vertical axis and the value on the horizontal axis, respectively, in the equirectangular projection image. With an input device such as the keyboard 511, the mouse 512, or the stylus 520, the user is able to input a predetermined rendering image, such as text, a line, or a figure, to the equirectangular projection image displayed in the rendering area 300. The user is also able to place another image different from the imported spherical image in the rendering area 300.

The Z-axis scroll bar 350 is an operation device for setting the rotation angle about the Z-axis (i.e., the vertical axis direction) as illustrated in FIG. 8. It is assumed here that the value of the rotation angle about the Z-axis ranges from −90 degrees to 90 degrees. Further, the Y-axis scroll bar 360 is an operation device for setting the rotation angle about the Y-axis (i.e., the horizontal axis direction) as illustrated in FIG. 8. It is assumed here that the value of the rotation angle about the Y-axis ranges from −180 degrees to 180 degrees. A ruler image 330 is an image representing the display position of the spherical image. For example, with the latitude (θ) and the longitude (φ), the ruler image 330 represents the display position of the equirectangular projection image representing the spherical image. The ruler image 330 displayed in the example of FIG. 15 has the origin (0°, 0°) at the coordinates (θ, φ) of the center of the rendering area 300. The position of the origin, however, is not limited thereto. The rendering area 300 also includes a label image 320 representing the display direction of the spherical image. The label image 320 includes labels spaced at intervals of 90 degrees, for example, such as F for the front side (0°, 0°), R for the right side (0°, 90°), L for the left side (0°, −90°), B for the back side (0°, 180°) and (0°, −180°), T for the top side (90°, 0°), and U for the bottom side (−90°, 0°). However, the label image 320 is not limited thereto, and may be any image expressed in a manner enabling the user to visually recognize the display position of the displayed spherical image.

A perspective projection button 250 is a selection device that is pressed to display, in the rendering area 300, the perspective projection image representing the area of a part of the spherical image. When the user presses the perspective projection button 250, the perspective projection image is displayed in the rendering area 300 to replace the equirectangular projection image. In this case, the grid image 310, the ruler image 330 representing the display position of the perspective projection image, and the label image 320 representing the display direction of the perspective projection image are displayed in the rendering area 300. The grid image 310, the ruler image 330, and the label image 320 are displayed as superimposed on the spherical image, and thus do not affect the spherical image stored in the captured image memory unit 57. The equirectangular projection image and the perspective projection image, which represent the spherical image, may be simultaneously displayed in the rendering area 300, or the display may be switched between the equirectangular projection image and the perspective projection image to separately display the equirectangular projection image and the perspective projection image.

Referring back to FIG. 14, if the import button 215 displayed on the rendering input screen 200 is selected by the user, the receiving unit 52 receives a request to import the captured image captured by the image capturing apparatus 10 (step S12). The transmitting and receiving unit 51 or the communication unit 55 transmits to the image capturing apparatus 10 a data acquisition request to request the image data of the captured image (step S13). Then, the transmitting and receiving unit 11 or the communication unit 13 of the image capturing apparatus 10 receives the data acquisition request transmitted from the PC 50. Then, the storing and reading unit 19 of the image capturing apparatus 10 reads the captured image data stored in the storage unit 1000 (step S14). The captured image data of the captured image previously captured by the imaging unit 15 is stored in the storage unit 1000. Then, the transmitting and receiving unit 11 or the communication unit 13 of the image capturing apparatus 10 transmits the captured image data read at step S14 to the PC 50 (step S15). Then, the transmitting and receiving unit 51 or the communication unit 55 of the PC 50 receives the captured image data transmitted from the image capturing apparatus 10.

If the file button 210 displayed on the rendering input screen 200 is selected by the user, on the other hand, the receiving unit 52 receives a captured image read request (step S16). The storing and reading unit 59 reads the captured image data previously stored in the storage unit 5000 (step S17).

Then, the display control unit 53 of the PC 50 controls the display 508 to display, in the rendering area 300 of the rendering input screen 200, the spherical image corresponding to the captured image based on the captured image data received at step S15 or read at step S17 (step S18). Specifically, the display control unit 53 controls the display 508 to display, in the rendering area 300, the equirectangular projection image representing the spherical image (e.g., the equirectangular projection image EC in FIG. 3C). Then, the captured image processing unit 56 stores the spherical image displayed at step S18 in the captured image memory unit 57 (step S19).

Then, the PC 50 executes a grid display process on the spherical image displayed in the rendering area 300 (step S20).

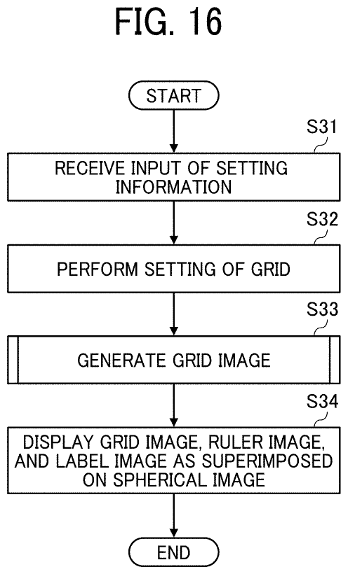

The process by the PC 50 to display the grid on the spherical image will be described with FIG. 16.

FIG. 16 is a flowchart illustrating an example of the grid display process performed by the PC 50 (i.e., the image processing apparatus) of the embodiment.

The receiving unit 52 first receives input of the setting information for setting the grid to the grid setting area 230 of the rendering input screen 200 displayed on the display 508 (step S31). Then, the grid setting unit 58 performs the setting of the grid with the setting information received at step S31 (step S32). Specifically, the grid setting unit 58 stores, as a record in the grid setting management table, the values of the items included in the received setting information.

Then, the grid ruler processing unit 62 generates the grid image 310 to be displayed in the rendering area 300 (step S33).

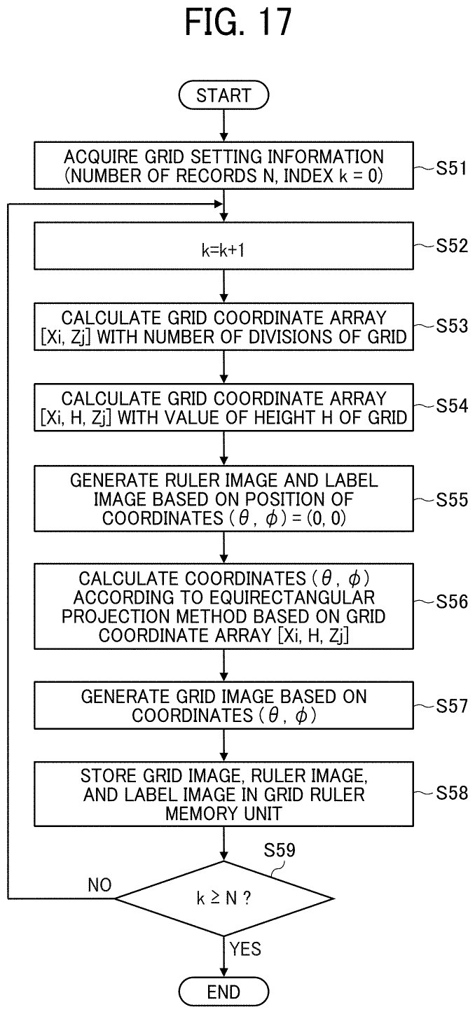

The process of step S33 to generate the grid image 310 will be described in detail with FIG. 17.

FIG. 17 is a flowchart illustrating an example of the grid image generation process performed by the PC 50 (i.e., the image processing apparatus) of the embodiment.

The grid ruler processing unit 62 of the PC 50 first acquires the setting information stored in the grid setting management table (step S51). Herein, the number of records of the grids to be set acquired by the grid ruler processing unit 62 is represented as N. and an index is represented as (k=0). The grid ruler processing unit 62 acquires all records stored in the grid setting management table. Then, the grid ruler processing unit 62 increments the index k by 1 (i.e., k+1) (step S52).

With the values of the grid width and the number of divisions included in the setting information acquired at step S51, the grid ruler processing unit 62 calculates a grid coordinate array [Xi, Zj] (step S53). Specifically, the grid ruler processing unit 62 first divides the value of the grid width by the number of divisions to calculate the width of each of cells of the grid (i.e., the width of each of the cells of the grid=the grid width/the number of divisions). The grid ruler processing unit 62 then calculates grid coordinates (first to fourth grid coordinates) for specifying the range of the grid to be set as: the first grid coordinates (x, z)=(−1×the grid width, −1×the grid width), the second grid coordinates (x, z)=(the grid width, −1×the grid width), the third grid coordinates (x, z)=(the grid width, the grid width), and the fourth grid coordinates (x, z)=(−1×the grid width, the grid width).

The grid ruler processing unit 62 then creates an array by multiplying the calculated width of each of the cells within the first to fourth grid coordinates by (the number of divisions−1). In this case, the grid ruler processing unit 62 calculates the X-axis coordinate and the Z-axis coordinate with a double-loop in which the value i in the X-axis direction and the value j in the Z-axis direction are looped (the number of divisions−1) times. A pseudo code for the calculation is given below.

```
Execute loop for i (the number of divisions − 1) times
  Execute loop for j (the number of divisions − 1) times
  Grid coordinate array [Xi, Zj] = (−1 × the grid width + the width
of each of the cells × i, −1 × the grid width + the width of each
of the cells × j)
  End loop for j
  End loop for i
```

Then, with the value of a height H included in the setting information acquired at step S51, the grid ruler processing unit 62 calculates a grid coordinate array [Xi, H, Zj] including the Y-axis coordinate (step S54). In this case, the grid ruler processing unit 62 calculates the Y-axis coordinate with a double-loop in which the value i in the X-axis direction and the value j in the Z-axis direction are looped (the number of divisions−1) times, similarly as in step S53. A pseudo code for the calculation is given below.

```
Execute loop for i (the number of divisions − 1) times
  Execute loop for j (the number of divisions − 1) times
  (x, z) = grid coordinate array [Xi, Zj]
  [Xi, H, Zj] = (x, H, z)
  End loop for j
  End loop for i
```

Then, based on the position of the coordinates (θ, φ)=(0, 0), the grid ruler processing unit 62 generates the ruler image 330 representing the display position of the spherical image and the label image 320 representing the display direction of the spherical image (step S55). Specifically, the grid ruler processing unit 62 generates a ruler along the horizontal axis with the value θ=0, and generates a ruler along the vertical axis with the value φ=0. The ruler image 330 may be graduated at regular intervals as in the example of FIG. 15, or may include numerical values of graduations at intervals of 30 degrees. The grid ruler processing unit 62 further generates labels at the corresponding coordinates (θ, φ) to enable the user who inputs rendering to visually recognize the display direction of the spherical image. As illustrated in FIG. 15, the label image 320 includes labels representing the display direction in the form of signs or text, for example, to enable the user to visually recognize the display direction of the spherical image, such as the front, back, right, left, top, and bottom sides, for example.

With the grid coordinate array [Xi, H, Zj] and the foregoing equation (4), the grid ruler processing unit 62 calculates the coordinates (θ, φ) according to the equirectangular projection method (step S56). For example, the grid ruler processing unit 62 extracts one set of grid coordinates (x, y, z) from the grid coordinate array [Xi, H, Zj], and converts the extracted grid coordinates (x, y, z) into the coordinates (θ, φ) according to the equirectangular projection method with equation (4).

The grid ruler processing unit 62 generates the grid image 310 based on the calculated coordinates (θ, φ) (step S57). The grid ruler processing unit 62 then stores, in the grid ruler memory unit 63, the ruler image 330 and the label image 320 generated at step S55 and the grid image 310 generated at step S57 (step S58). Then, if the value of the index k is equal to or greater than the number of records N (YES at step S59), the grid ruler processing unit 62 completes the procedure. If the value of the index k is smaller than the number of records N (NO at step S59), on the other hand, the grid ruler processing unit 62 repeats the processes of step S52 and the subsequent steps.

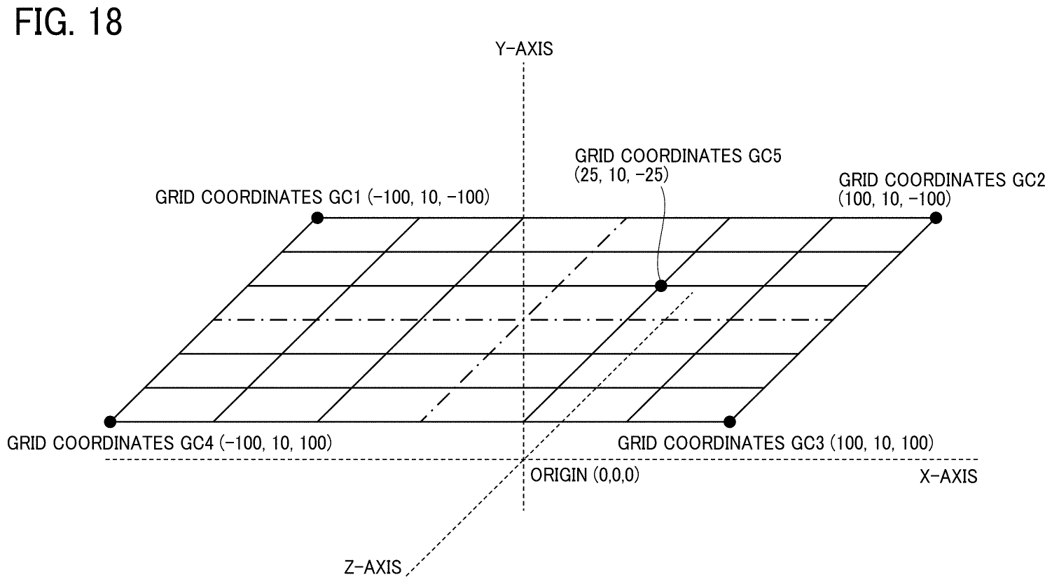

The grid image 310 generated by the grid image generation process in FIG. 17 will be schematically described with FIG. 18.

FIG. 18 is a conceptual diagram illustrating an example of a grid in a three-dimensional Euclidean space. FIG. 18 illustrates a grid coordinate array of the grid image 310 in a three-dimensional Euclidean space generated based on the grid settings illustrated in FIG. 15, for example. The unit of the coordinates, which is centimeter (cm) or meter (m), for example, is changeable as appropriate. If the image capturing apparatus 10 is placed at a position corresponding to a height of 10 cm from the floor, for example, the grid setting unit 58 sets the value of the height H to 10.

Further, each of points for rendering the grid is represented by the grid coordinates (x, y, z). FIG. 18 illustrates an example in which a grid with a height value of 10 and a grid width value of 200 is divided into fifths. Herein, the height value of 10 indicates that the grid is arranged at a position corresponding to the value 10 on the Y-axis from the origin of the three-dimensional Euclidean space. The values of the items included in the setting information are settable in the grid setting area 230 of the rendering input screen 200 illustrated in FIG. 15.

The grid ruler processing unit 62 first calculates the coordinates of points obtained by dividing the segment between grid coordinates GC1 (−100, 10, −100) and grid coordinates GC2 (100, 10, −100) in the X-axis direction. The grid ruler processing unit 62 then calculates the coordinates of points obtained by dividing the segment between the grid coordinates GC2 (100, 10, −100) and grid coordinates GC3 (100, 10, 100) in the Z-axis direction. For example, grid coordinates GC5 are calculated as (25, 10, −25).

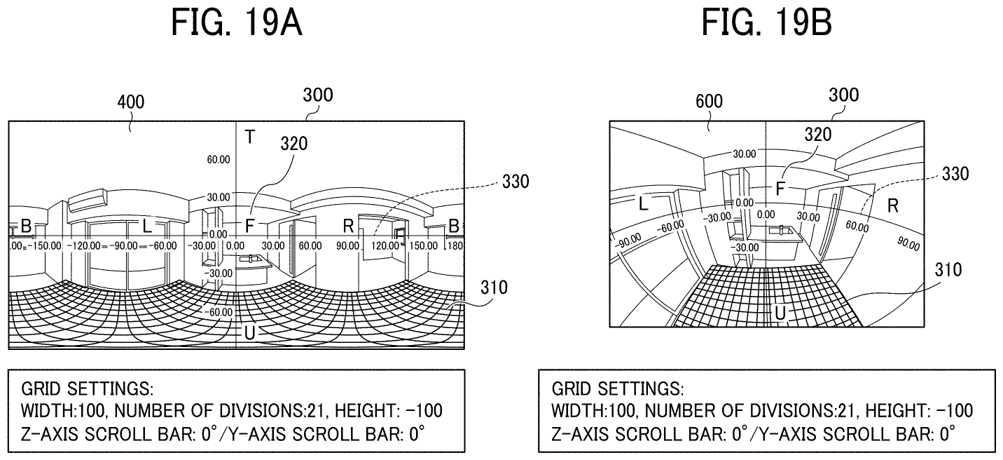

With the process of step S56, the grid ruler processing unit 62 converts the above-described grid coordinates into the coordinates in a spherical polar coordinate system to acquire the coordinates (θ, φ) according to the equirectangular projection method, thereby generating the grid image 310 to be displayed at the acquired coordinates (θ, φ). Herein, the foregoing equation (4) is used to convert the grid coordinates (x, y, z) into the coordinates (θ, φ). Then, the display control unit 53 displays the generated grid image 310 to be superimposed on an equirectangular projection image 400 (see FIG. 19A, for example).

If the display image is rotated about the Z-axis or the Y-axis in a later-described process, the rotation processing unit 61 converts the grid coordinates (x, y, z) into the grid coordinates (x″, y″, z″) in accordance with the coordinate conversion as illustrated in FIG. 8, and then converts the grid coordinates (x″, y″, z″) into the position coordinates (r, θ, φ) of the center point CP, to thereby acquire the coordinates (θ, φ) according to the equirectangular projection method. Then, the display control unit 53 displays the grid image 310 at the acquired coordinates (θ, φ) to be superimposed on the equirectangular projection image 400. In the example illustrated in FIG. 18, the grid image 310 is displayed on a plane parallel to the X-axis and the Z-axis. Alternatively, the grid setting may be performed such that the grid image 310 is displayed on a plane parallel to the Y-axis and the Z-axis or a plane parallel to the X-axis and the Y-axis. With the setting information input to the grid setting area 230, therefore, the PC 50 is able to set and display the grid according to the display state of the spherical image. Consequently, convenience is improved for the user who inputs rendering.

Referring back to FIG. 16, the display control unit 53 of the PC 50 displays a display image in which the generated grid image 310 is superimposed on the spherical image displayed on the display 508 (step S34).

Examples of the display image displayed in the rendering area 300 will be described with FIGS. 19A and 19B to FIGS. 21A and 21B.

FIG. 19A illustrates a display image in which the grid image 310 representing a grid with the grid width, the number of divisions, and the height set to 100, 21, and −100, respectively, the ruler image 330, and the label image 320 are superimposed on the equirectangular projection image 400 representing the spherical image. FIG. 19B illustrates a display image in which the grid image 310, the ruler image 330, and the label image 320 are superimposed on a perspective projection image 600 corresponding to the image of the area of a part of the spherical image. Each of the display images illustrated in FIGS. 19A and 19B includes the grid image 310, the ruler image 330, and the label image 320, the display state of which matches the display state of the equirectangular projection image 400 or the perspective projection image 600.

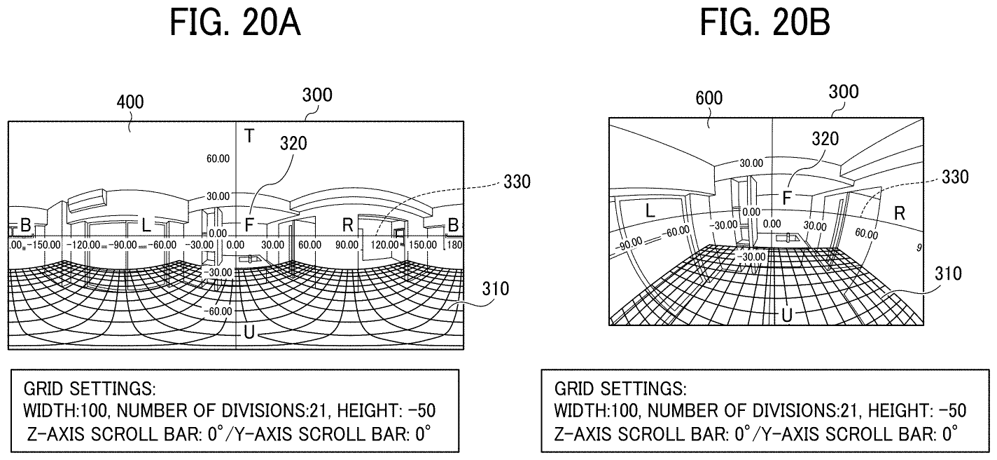

Each of FIGS. 20A and 20B illustrates a display image in which the grid image 310 representing a grid with the grid width, the number of divisions, and the height set to 100, 21, and −50, respectively, the ruler image 330, and the label image 320 are superimposed on the captured image. The display image illustrated in FIG. 20A is obtained by changing the relative height of the grid image 310 illustrated in FIG. 19A, and the display image illustrated in FIG. 20B is obtained by changing the relative height of the grid image 310 illustrated in FIG. 19B. In FIGS. 19A and 19B, the grid image 310 is arranged at the position of the floor of the subject included in the captured image. In FIGS. 20A and 20B, on the other hand, the grid image 310 is arranged at a position above the floor of the subject by a predetermined distance. With the grid settings, therefore, the height at which the grid image 310 is arranged on the captured image is changeable in accordance with the contents or position of the rendering, for example.

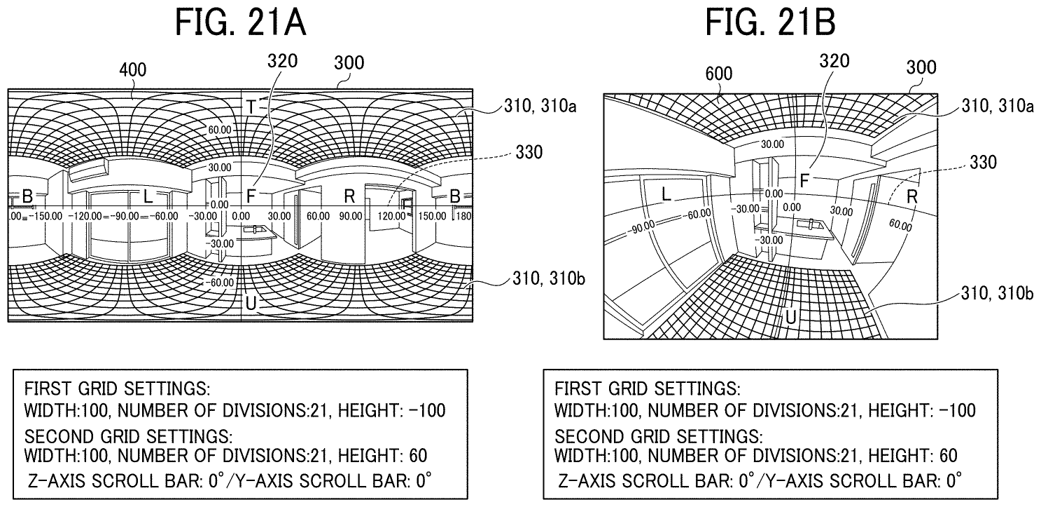

Each of FIGS. 21A and 21B illustrates a display image in which the two grid images 310a and 310b are superimposed on the spherical image. As illustrated in FIGS. 21A and 21B, the PC 50 is capable of displaying a plurality of grid images 310 (e.g., the grid images 310a and 310b) in accordance with the input to the grid setting area 230 of the rendering input screen 200.

As described above, the PC 50 displays the grid image 310 as superimposed on the spherical image displayed in the rendering area 300 (i.e., the equirectangular projection image 400 or the perspective projection image 600), to thereby enable the user to accurately input a desired rendering image. The PC 50 further displays the ruler image 330 representing the display position of the spherical image and the label image 320 representing the display direction of the spherical image such that the ruler image 330 and the label image 320 are superimposed on the spherical image, to thereby enable the user to visually recognize the position and direction of the spherical image to which the user intends to input rendering. Further, the PC 50 switches the display between the equirectangular projection image 400 and the perspective projection image 600, which display the spherical image in different methods, thereby implementing a rendering method according to the need of the user. Herein, the equirectangular projection image 400 is an example of a first image, and the perspective projection image 600 is an example of a second image.

Referring back to FIG. 14, the PC 50 executes a display image rotation process to rotate the display image displayed on the display 508 (step S21).

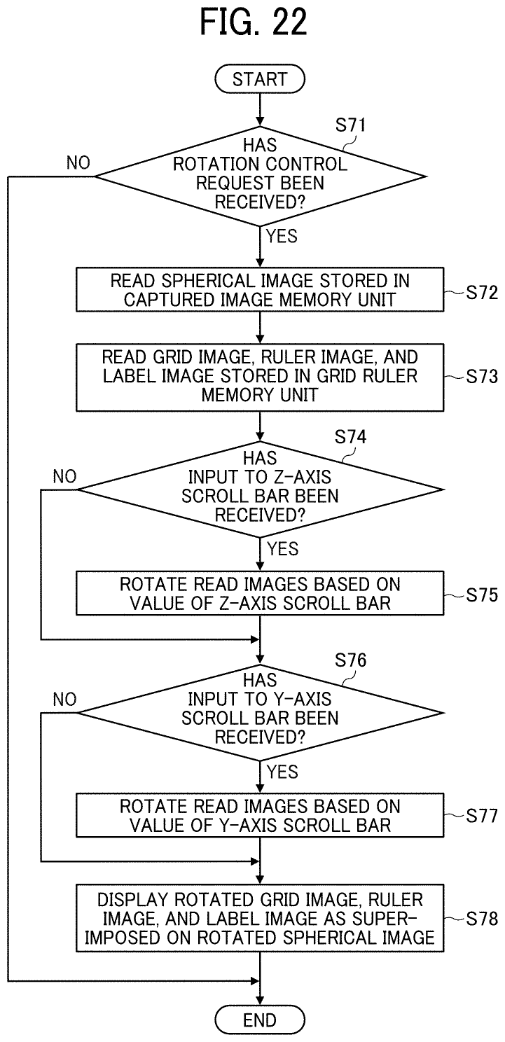

The display image rotation process of step S21 will be described in detail with FIG. 22.

FIG. 22 is a flowchart illustrating an example of the display image rotation process performed by the PC 50 (i.e., the image processing apparatus) of the embodiment.

The determination unit 54 of the PC 50 first determines whether a rotation control request for rotating the display image has been received by the receiving unit 52 (step S71). For example, if the input to the Z-axis scroll bar 350 or the Y-axis scroll bar 360 in the rendering input screen 200 has been received by the receiving unit 52, the determination unit 54 determines that the rotation control request has been received. If the determination unit 54 determines that the rotation control request has been received (YES at step S71), the procedure proceeds to step S72. If the determination unit 54 determines that the rotation control request has not been received (NO at step S71), on the other hand, the procedure is completed.

Then, the captured image processing unit 56 reads the spherical image stored in the captured image memory unit 57 (step S72). Further, the grid ruler processing unit 62 reads the grid image 310, the ruler image 330, and the label image 320 stored in the grid ruler memory unit 63 (step S73). In the following description, the images read at steps S72 and S73 will be described as the read images.

Then, if the input to the Z-axis scroll bar 350 has been received by the receiving unit 52 (YES at step S74), the procedure proceeds to step S75. If the input to the Z-axis scroll bar 350 has not been received by the receiving unit 52 (NO at step S74), on the other hand, the procedure proceeds to step S76. Then, with the input value of the Z-axis scroll bar 350 received at step S74 and the foregoing equation (2), the rotation processing unit 61 rotates, about the Z-axis (i.e., the vertical axis direction), the read images read at steps S72 and S73 (step S75). Specifically, the rotation processing unit 61 extracts the rotation angle about the Z-axis from the value of the Z-axis scroll bar 350, and rotates the display of the read images about the Z-axis in accordance with the extracted rotation angle.

Then, if the input to the Y-axis scroll bar 360 has been received by the receiving unit 52 (YES at step S76), the procedure proceeds to step S77. If the input to the Y-axis scroll bar 360 has not been received by the receiving unit 52 (NO at step S76), on the other hand, the procedure proceeds to step S78. Then, with the input value of the Y-axis scroll bar 360 received at step S76 and the foregoing equation (3), the rotation processing unit 61 rotates, about the Y-axis (i.e., the horizontal axis direction), the read images read at steps S72 and S73 or rotated at step S75 (step S77). Specifically, the rotation processing unit 61 extracts the rotation angle about the Y-axis from the value of the Y-axis scroll bar 360, and rotates the display of the read images about the Y-axis in accordance with the extracted rotation angle.

Then, the display control unit 53 displays the rotated grid image 310, ruler image 330, and label image 320 as superimposed on the rotated spherical image rotated at steps S75 and S77 (step S78).

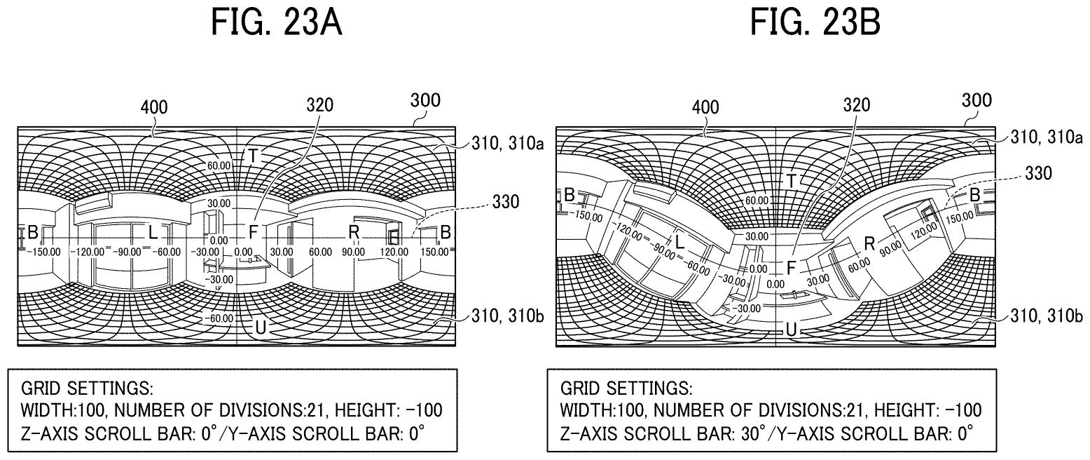

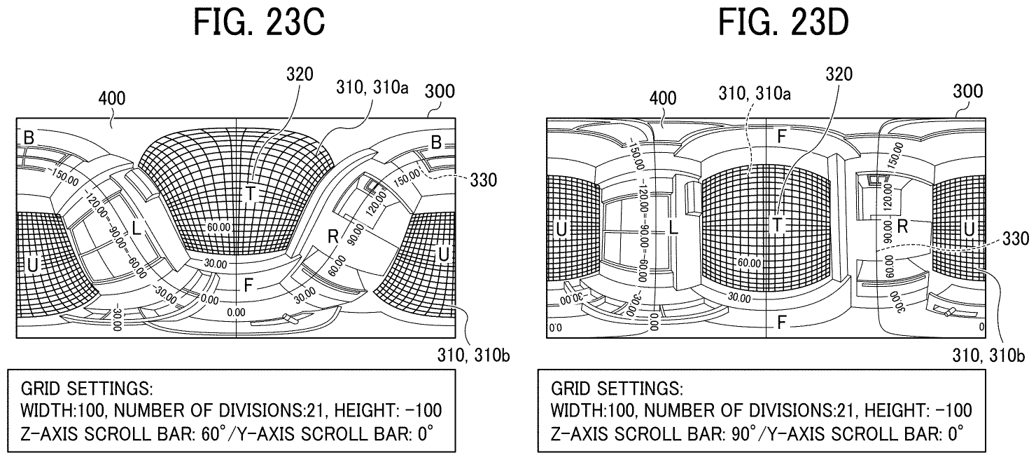

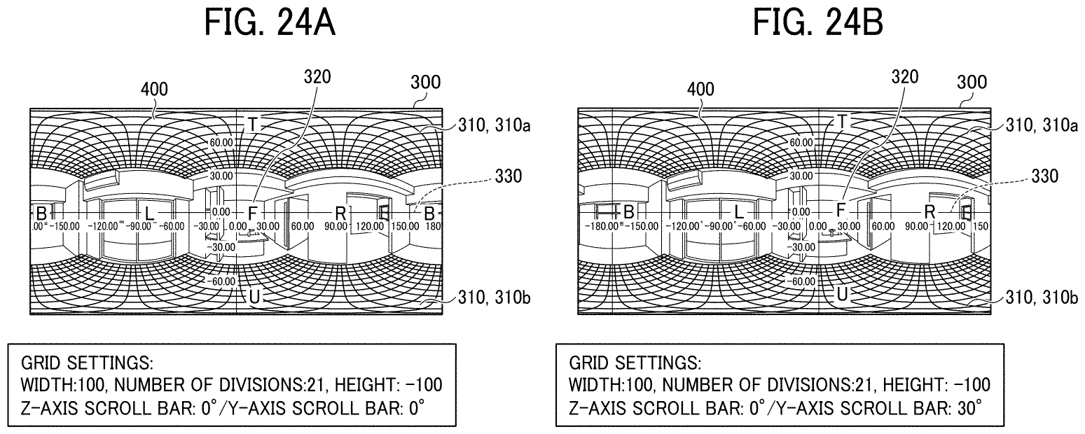

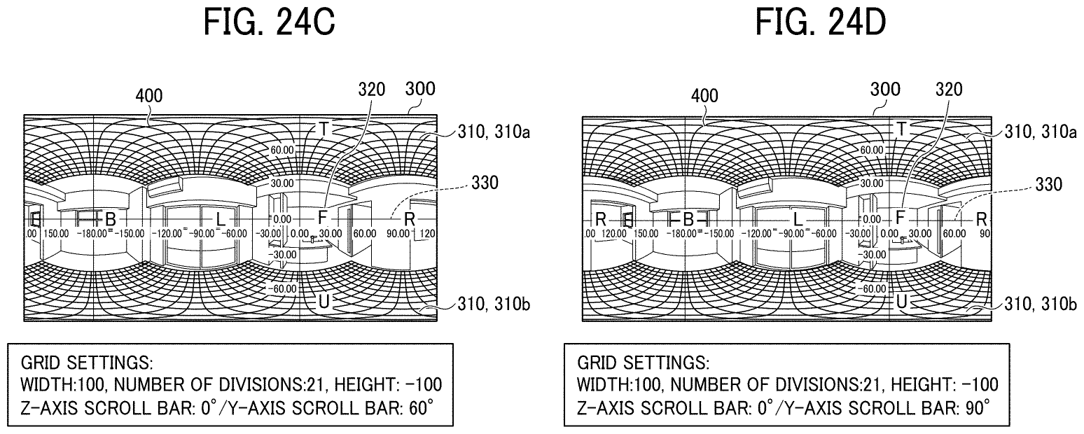

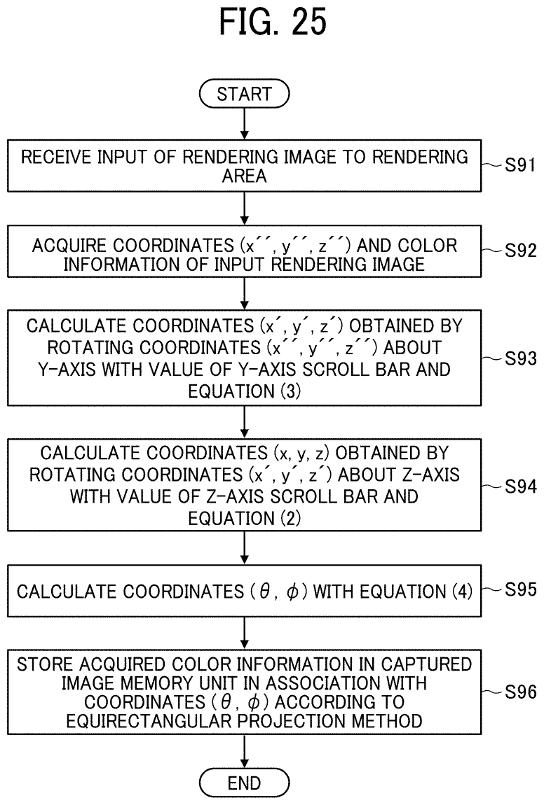

With FIGS. 23A, 23B, 23C, and 23D and FIGS. 24A, 24B, 24C, and 24D, a description will be given of an example in which the display image displayed in the rendering area 300 is rotated to change the display position or the display direction.

FIGS. 23A to 23D illustrate display states obtained by rotating the display image about the Z-axis (i.e., the vertical axis direction) in a phased manner. FIG. 23A illustrates the same display state as that of the display image illustrated in FIG. 21A, in which the grid image 310, the ruler image 330, and the label image 320 are displayed as superimposed on the equirectangular projection image 400. FIG. 23B illustrates a display state obtained by rotating the display image in FIG. 23A about the Z-axis by 30 degrees. FIG. 23C illustrates a display state obtained by rotating the display image in FIG. 23A about the Z-axis by 60 degrees. FIG. 23D illustrates a display state obtained by rotating the display image in FIG. 23A about the Z-axis by 90 degrees. As illustrated in FIGS. 23A to 23D, the distortion of the equirectangular projection image 400 increases with the rotation about the Z-axis.

When the equirectangular projection image 400 is rotated about the Z-axis, therefore, the PC 50 also rotates the grid image 310, the ruler image 330, and the label image 320, which are displayed as superimposed on the equirectangular projection image 400, such that the grid image 310, the ruler image 330, and the label image 320 are displayed at the display position or in the display direction matching the display position or the display direction of the rotated equirectangular projection image 400. Even if the display image is rotated, therefore, the user is able to input rendering while viewing the grid image 310, the ruler image 330, and the label image 320, the display state of which matches the display state of the rotated equirectangular projection image 400. Consequently, the user is able to accurately input the rendering image.

FIGS. 24A to 24D illustrate display states obtained by rotating the display image about the Y-axis (i.e., the horizontal axis direction) in a phased manner. FIG. 24A illustrates the same display state as that of the display image illustrated in FIG. 21A. FIG. 24B illustrates a display state obtained by rotating the display image in FIG. 24A about the Y-axis by 30 degrees. FIG. 24C illustrates a display state obtained by rotating the display image in FIG. 24A about the Y-axis by 60 degrees. FIG. 24D illustrates a display state obtained by rotating the display image in FIG. 24A about the Y-axis by 90 degrees. Being rotated about the Y-axis, each of the display images in the display states illustrated in FIGS. 24A to 24D has the display position thereof slid in the horizontal axis direction. Thereby, the grid image 310, the ruler image 330, and the label image 320 are displayed as superimposed on the equirectangular projection image 400 such that the display position or the display direction of the grid image 310, the ruler image 330, and the label image 320 matches the display position or the display direction of the equirectangular projection image 400.

Even if the display image displayed in the rendering area 300 is rotated about the Z-axis (i.e., the vertical axis direction) or about the Y-axis (i.e., the horizontal axis direction), therefore, the user of the PC 50 is able to input rendering while visually checking the display position or the display direction of the spherical image with the grid image 310, the ruler image 330, and the label image 320.

Referring back to FIG. 14, the PC 50 executes a rendering process on the spherical image (step S22). FIG. 25 is a flowchart illustrating an example of the rendering process on the spherical image performed by the PC 50 (i.e., the image processing apparatus) of the embodiment.

The receiving unit 52 of the PC 50 first receives input of a rendering image to the rendering area 300 (step S91). Then, the captured image processing unit 56 of the PC 50 acquires the coordinates (x″, y″, z″) and the information of the color of the rendering image input at step S91 (step S92).

With the value of the Y-axis scroll bar 360 and the foregoing equation (3), the captured image processing unit 56 calculates the coordinates (x′, y′, z′), which are obtained by rotating the coordinates (x″, y″, z″) acquired at step S92 about the Y-axis (step S93). With the value of the Z-axis scroll bar 350 and the foregoing equation (2), the captured image processing unit 56 then calculates the coordinates (x, y, z), which are obtained by rotating the coordinates (x′, y′, z′) calculated at step S93 about the Z-axis (step S94).

With the foregoing equation (4), the captured image processing unit 56 further calculates the coordinates (θ, φ) according to the equirectangular projection method, which are converted from the coordinates (x, y, z) calculated at step S94 (step S95). The captured image processing unit 56 then stores the information of the color of the acquired rendering image in the captured image memory unit 57 in association with the calculated coordinates (θ, φ) (step S96).

As described above, even if rendering is input to the rotated spherical image, the PC 50 is capable of calculating the coordinates according to the equirectangular projection method with equation (4), thereby enabling the user to input rendering at a desired position on the spherical image.

Typical methods of performing rendering (i.e., writing) on the spherical mage include a method of performing rendering while displaying, on a two-dimensional plane, the entirety of the spherical image represented by the equirectangular projection image generated by the equirectangular projection method and a method of performing rendering while displaying, on a two-dimensional plane, the perspective projection image obtained by cutting out the area of a part of the spherical image. According to the method using the equirectangular projection image, the entire display image is distorted, making it difficult to directly edit the display image or perform writing on the display image. The method using the perspective projection image, on the other hand, is capable of displaying an undistorted rectangular image with specification of the elevation angle ea and the azimuth angle ea (see FIG. 6). This method, however, displays a limited part of the spherical image, and thus reduces the area to which the user is able to input rendering, making it difficult for the user to identify which part of the spherical image is the currently rendered area.

According to the image processing system 1 of the embodiment, on the other hand, the grid image 310 for identifying the relative position of the subject included in the spherical image is displayed as superimposed on the equirectangular image 400, enabling the user to input rendering while using the grid as a guide. For example, when the elevation angle or the azimuth angle according to the equirectangular projection method is changed with the rotation of the display image, the image processing system 1 displays the equirectangular image 400 and the grid image 310 both in a transformed state (see FIGS. 23A to 23D and FIGS. 24A to 24D, for example), thereby enabling the user to perform rendering while checking the distortion or direction of the grid image 310. Consequently, the user of the PC 50 is able to input rendering to the spherical image while having an overall view of the spherical image, without losing track of the display direction of the spherical image or being affected by image distortion.

As described above, an embodiment of the present invention provides an image processing method executed by the PC 50 (an example of the image processing apparatus) that performs predetermined rendering on the spherical image. The image processing method includes receiving the settings of the grid for identifying the relative position of the subject included in the spherical image, displaying, on the display 508 (an example of a display), the display image including the spherical image and the grid image 310 superimposed on the spherical image, and receiving input of rendering to the spherical image in the displayed display image. The grid image 310 is generated in accordance with the received settings of the grid. The image processing method of the embodiment of the present invention therefore displays the grid image 310 as superimposed on the spherical image, thereby enabling the user to accurately input desired rendering.

According to the image processing method of the embodiment of the present invention, the receiving the settings of the grid includes receiving the settings of the relative height of the grid relative to the viewpoint position for viewing the spherical image, the width of the grid, and the number of divisions for dividing the grid, for example. Further, the displaying includes displaying, on the display 508 (an example of the display), the grid image 310 generated in accordance with the received setting of the relative height of the grid such that the grid image 310 is superimposed on the spherical image. The image processing method of the embodiment of the present invention therefore sets and displays the grid in accordance with the display state of the spherical image, thereby improving convenience for the user who inputs rendering.

According to the image processing method of the embodiment of the present invention, the spherical image is represented as the equirectangular projection image 400 (an example of the first image) generated by the equirectangular projection method. The image processing method further includes receiving an input for rotating the displayed equirectangular projection image 400, and rotating the displayed equirectangular projection image 400 and the displayed grid image 310 in accordance with the received input. Further, the displaying includes displaying, on the display 508 (an example of the display), the display image including the rotated equirectangular projection image 400 and the rotated grid image 310, and the receiving the input of the rendering includes receiving the input of the rendering to the spherical image in the rotated display image.

The image processing method of the embodiment of the present invention therefore displays the grid image 310 for identifying the relative position of the subject included in the spherical image such that the grid image 310 is superimposed on the equirectangular projection image 400, thereby enabling the user to input rendering while using the grid as a guide. Further, when the equirectangular projection image 400 is rotated, the image processing method displays, as well as the rotated equirectangular projection image 400, the grid image 310 in a transformed state, thereby enabling the user to perform rendering with reference to the distortion or direction of the grid image 310. Even if the display image displayed in the rendering area 300 is rotated, therefore, the user of the PC 50 (an example of the image processing apparatus) is able to input rendering to the spherical image without losing track of the display position or the display direction of the spherical image or being affected by image distortion.

Further, according to the image processing method of the embodiment of the present invention, the displaying includes displaying, on the display 508 (an example of the display), the ruler image 330 and the label image 320 as superimposed on the equirectangular projection image 400. The ruler image 330 represents the display position of the equirectangular projection image 400 (an example of the first image). The label image 320 represents the display direction of the equirectangular projection image 400. Further, the receiving the input for rotating the displayed equirectangular projection image 400 includes receiving the input for rotating the displayed equirectangular projection image 400 about the vertical axis direction. The rotating includes rotating the displayed display image about the vertical axis direction in accordance with the received input. The displayed display image includes the equirectangular projection image 400, the grid image 310, the ruler image 330, and the label image 320. The image processing method of the embodiment of the present invention therefore displays the ruler image 330 and the label image 320 as superimposed on the spherical image, thereby enabling the user to visually recognize the position and direction of the spherical image to which the user intends to input rendering.

According to the image processing method of the embodiment of the present invention, the displaying includes displaying, on the display 508 (an example of the display), the perspective projection image 600 (an example of the second image), which represents the area of a part of the spherical image. The image processing method of the embodiment of the present invention therefore switches the display between the equirectangular projection image 400 and the perspective projection image 600, which display the spherical image in different methods, thereby implementing a rendering method according to the need of the user.

Tables such as the grid setting management table of the embodiment described above may be generated by machine learning. The mutually associated data items in each of the tables may be categorized by machine learning to obviate the need for the tables. Herein, machine learning refers to a technology for causing a computer to acquire learning ability similar to human learning ability. According to the technology, the computer autonomously generates, from previously learned data, algorithms for making decisions such as data identification, and makes predictions by applying the algorithms to new data. The learning method for machine learning may be any of supervised learning, unsupervised learning, semi-supervised learning, reinforcement learning, and deep learning, or may be a learning method combining two or more of these learning methods. The learning method for machine learning is not limited to a particular method.

In this disclosure, examples of superimposition of images include, but not limited to, placement of one image on top of another image entirely or partly, laying one image over another image entirely or partly, mapping one image on another image entirely or partly, pasting one image on another image entirely or partly, combining one image with another image, and integrating one image with another image. That is, as long as the user can perceive a plurality of images (such as the spherical image and the planar image) being displayed on a display as they were one image, processing to be performed on those images for display is not limited to the above-described examples.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An image processing method comprising:
receiving settings of a grid for identifying a relative position of a subject included in a spherical image;
displaying, on a display, a display image including the spherical image and a grid image superimposed on the spherical image, the grid image being generated in accordance with the received settings of the grid; and
receiving an input of rendering to the spherical image in the displayed display image.

2. The image processing method of claim 1, wherein the receiving the settings of the grid includes receiving a setting of a relative height of the grid relative to a viewpoint position for viewing the spherical image, and
wherein the displaying includes displaying, on the display, the grid image as superimposed on the spherical image, the grid image being generated in accordance with the received setting of the relative height of the grid.

3. The image processing method of claim 1, further comprising generating the grid image in accordance with the received settings of the grid,
wherein the displaying includes displaying, on the display, the generated grid image as superimposed on the spherical image.

4. The image processing method of claim 3, wherein the receiving the settings of the grid includes receiving settings of a width of the grid and a number of divisions for dividing the grid, and
wherein the generating includes generating the grid image in accordance with the received settings of the width of the grid and the number of divisions.

5. The image processing method of claim 1, wherein the grid includes a plurality of grids,
wherein the receiving the settings of the grid includes receiving settings of the plurality of grids, and
wherein the displaying includes displaying, on the display, a plurality of grid images as superimposed on the spherical image, the plurality of grid images being generated in accordance with the received settings of the plurality of grids.

6. The image processing method of claim 1, wherein the displaying includes displaying, on the display, the grid image as superimposed on a first image, the first image being generated by an equirectangular projection method to represent the spherical image.

7. The image processing method of claim 6, further comprising:
receiving an input for rotating the displayed first image; and
rotating the displayed first image and grid image in accordance with the received input for rotating the displayed first image,
wherein the displaying includes displaying, on the display, the display image including the rotated first image and grid image, and
wherein the receiving the input of the rendering includes receiving the input of the rendering to the spherical image in the rotated display image.

8. The image processing method of claim 7, wherein the receiving the input for rotating the displayed first image includes receiving an input for rotating the displayed first image about a horizontal axis direction, and
wherein the rotating the displayed first image and grid image includes rotating the displayed display image about the horizontal axis direction in accordance with the received input for rotating the displayed first image.

9. The image processing method of claim 7, wherein the receiving the input for rotating the displayed first image includes receiving an input for rotating the displayed first image about a vertical axis direction, and
wherein the rotating the displayed first image and grid image includes rotating the displayed display image about the vertical axis direction in accordance with the received input for rotating the displayed first image.

10. The image processing method of claim 7, wherein the displaying includes displaying, on the display, a ruler image and a label image both as superimposed on the first image, the ruler image representing a display position of the first image, and the label image representing a display direction of the first image,
wherein the receiving the input for rotating the displayed first image includes receiving an input for rotating the displayed first image about a vertical axis direction, and
wherein the rotating the displayed first image and grid image includes rotating the displayed display image about the vertical axis direction in accordance with the received input for rotating the displayed first image, the displayed display image including the first image, the grid image, the ruler image, and the label image.

11. The image processing method of claim 1, wherein the displaying includes displaying, on the display, a second image representing an area of a part of the spherical image.

12. A non-transitory recording medium storing a plurality of instructions which, when executed by one or more processors, cause the processors to perform an image processing method comprising:
receiving settings of a grid for identifying a relative position of a subject included in a spherical image;
displaying, on a display, a display image including the spherical image and a grid image superimposed on the spherical image, the grid image being generated in accordance with the received settings of the grid; and
receiving an input of rendering to the spherical image in the displayed display image.

13. An image processing apparatus comprising circuitry configured to
receive settings of a grid for identifying a relative position of a subject included in a spherical image,
control a display to display a display image including the spherical image and a grid image superimposed on the spherical image, the grid image being generated in accordance with the received settings of the grid, and
receive an input of rendering to the spherical image in the displayed display image.

14. The image processing apparatus of claim 13, wherein the circuitry is further configured to generate the spherical image from a plurality of captured images.

15. An image processing system comprising:
the image processing apparatus of claim 13; and
an image capturing apparatus communicable with the image processing apparatus, and configured to generate the spherical image from a plurality of captured images.
